(19) United States
(12) Patent Application Publication
(10) Pub. No.: US 2026/0074394 A1
(43) Pub. Date: Mar. 12, 2026

(54) CONDUCTIVE STRUCTURE AND MANUFACTURING METHOD THEREOF, COVER PLATE ASSEMBLY, AND BATTERY CELL

(71) Applicants: Huizhou EVE Power Co., Ltd., Guangdong (CN); EVE Power Co., Ltd., Jingmen (CN)

(72) Inventors: Wei HE, Jingmen (CN); Xu ZHENG, Jingmen (CN); Kuanjin SHU, Jingmen (CN); Dong DUAN, Jingmen (CN); Ziwen LIU, Jingmen (CN)

(73) Assignees: Huizhou EVE Power Co., Ltd., Guangdong (CN); EVE Power Co., Ltd., Jingmen (CN)

(21) Appl. No.: 19/321,837

(22) Filed: Sep. 8, 2025

(30) Foreign Application Priority Data
Sep. 6, 2024 (CN) 202411252093.7

(51) Int. Cl. H01M 50/562; H01M 50/169; H01M 50/172; H01M 50/188

(52) U.S. Cl. CPC H01M 50/562; H01M 50/169; H01M 50/172; H01M 50/188

(57) ABSTRACT

A conductive structure and a manufacturing method, a cover plate assembly, and a battery cell are provided. The conductive structure includes a metal post including a first end and a second end opposite to each other. A metal layer bonded to a surface of the metal post. The metal layer wraps the first end and extends toward the second end. The metal layer is configured to connect to a tab. In the conductive structure, the metal layer bonded to the surface of the first end of the metal post is arranged to extend from the surface of the first end of the metal post to the second end. An end surface of the first end of the metal post and at least part of a surface of the metal post are covered by the metal layer.

### RELATED APPLICATION

The present application claims priority of Chinese Patent Application No. 202411252093.7, filed on Sep. 6, 2024. The entire disclosure of the prior application is hereby incorporated by reference.

### TECHNICAL FIELD

The present application relates to the technical field of batteries, including to a conductive structure, a manufacturing method of a conductive structure, a cover plate assembly, and a battery cell.

### BACKGROUND

A pole is an important component that connects the inside with outside of a battery core (also referred to as a battery cell). Generally, an end of the pole is connected to an external circuit outside the battery core, such as being connected to a module bus bar, and another end of the pole is connected to an internal circuit inside the battery core, such as being connected to a tab of an electrode assembly through a current collector. Currently, most poles are made of single metal material, for example, a positive pole is made of aluminum and a negative pole is made of copper. However, the poles made of a single metal material are easy to pose welding difficulties. Taking the negative pole as an example of a pure copper pole as an example, when the pure copper pole and a terminal pressing block are welded by laser, in order to reduce the costs and the weight of the battery core, the terminal pressing block is generally made of aluminum. However, due to the difference in melting points between copper and aluminum, laser welding may easily fail, leading to cracking.

In order to reduce the difficulty of welding, a composite pole is designed in related arts. The composite pole includes two metal layers of different materials stacked on top and bottom, and the different metal layers are joined together by friction welding or stamping. Taking the composite pole as an example of the negative pole, the composite pole includes an aluminum layer and a copper layer. However, the bonding strength between different metal layers in the composite pole is limited, leading to the metal layer connected to an electrode assembly easily detaching and falling into the interior of the battery core, thereby resulting in the failure of the battery core.

### SUMMARY

The present disclosure provides a conductive structure and a manufacturing method thereof, a cover plate assembly, and a battery cell, which can address the technical problem of a metal layer in a composite pole easily detaching.

In an aspect of the present disclosure provide a conductive structure, including:
a first-metal post including a first end and a second end opposite to each other; and
a second-metal layer bonded to a surface of the first-metal post, wherein the second-metal layer wraps the first end and extends toward the second end, and the second-metal layer is configured to connect to a tab.

In an aspect, the second-metal layer and the first-metal post are cooperated with each other in an embedding manner.

In an aspect, an end portion of the second-metal layer is embedded in the first-metal post.

In an aspect, a gap is presented between the end portion of the second-metal layer and the first-metal post.

In an aspect, an end surface and a transition surface connected in sequence are formed on the end portion of the second-metal layer, and the gap is formed only between the end surface and the transition surface and the first-metal post, a side of the end surface away from the transition surface is connected to an outer surface of the second-metal layer, and the transition surface is curved and transitioned from the end surface onto the first-metal post.

In an aspect, an average dimension of the gap is less than 0.1 mm.

In an aspect, an end portion of the second-metal layer includes a first extension segment and/or a second extension segment, the first extension segment extends in a first direction, the second extension segment extends in a second direction, and the first direction intersects with the second direction.

In an aspect, the conductive structure is a pole, a supporting surface is formed on an end portion of the second-metal layer, and the supporting surface is configured to support a terminal pressing block.

In an aspect, the supporting surface is an inclined surface, and in a direction away from the first end, the inclined surface gradually approaches an outer side surface of the first-metal post from an outer side surface of the second-metal layer.

In an aspect, the inclined surface is an inclined flat surface, and an included angle between the inclined flat surface and the outer side surface of the second-metal layer ranges from 110° to 130°.

In an aspect, the supporting surface is a step surface, the step surface includes a first sub-step surface and a second sub-step surface connected in sequence, a number of the first sub-step surface is greater than or equal to 1, and a number of the second sub-step surface is greater than or equal to 1.

In an aspect, a height of the second sub-step surface along an axial direction of the pole is greater than or equal to 0.2 mm, and/or a width of the first sub-step surface along a radial direction of the pole is greater than or equal to 0.2 mm.

In an aspect, a width of the supporting surface along a radial direction of the pole is greater than or equal to 0.3 mm and is less than or equal to a thickness of the second-metal layer.

In an aspect, the first-metal post is radially protruded to form a boss, and the second-metal layer extends at least onto the boss.

In an aspect, the boss is located at the first end, and the boss is completely encased within the second-metal layer.

In an aspect, the conductive structure is a pole and a current collector integrated with each other, the boss is the current collector, the current collector is configured to be connected with a tab.

In an aspect, the boss is arranged away from the first end, and a radial dimension of the boss is greater than a radial dimension of the first end.

In an aspect, the boss is located at the second end, and the boss portion is exposed outside the second-metal layer.

In an aspect, the conductive structure is a pole and a terminal pressing block integrated with each other, and the boss is the terminal pressing block.

In an aspect, the second-metal layer includes a first section, a second section, and a third section, the first section corresponds to an end surface of the first end, the second section corresponds to a side surface of the first end, the third section corresponds to a side surface of the boss adjacent to the first end, and the second section connects the first section with the third section.

In an aspect, the third section is formed as an end portion of the second-metal layer, and the third section is embedded in the boss.

In an aspect, an average thickness of the first section is greater than an average thickness of the second section, and the average thickness of the second section is greater than an average thickness of the third section.

In an aspect, the average thickness of the second section is greater than half of the average thickness of the first section, and/or the average thickness of the third section is greater than half of the average thickness of the second section.

In an aspect, a thickness of a portion of the second section adjacent to the third section is greater than a thickness of a portion of the second section adjacent to the first section.

In an aspect, the end surface of the first end is locally recessed to form a groove, the first section includes a first sub-section, a second sub-section, and a third sub-section connected in sequence, the first sub-section is located outside the groove, the second sub-section is located on a sidewall of the groove, and the third sub-section is located on a bottom wall of the groove.

In an aspect, a vertical distance between an outer surface of the first sub-section and an outer surface of the third sub-section is less than or equal to 2.5 mm.

In an aspect, an average thickness of the first sub-section is greater than or equal to 0.5 mm, and/or the average thickness of the second section is greater than or equal to 0.5 mm.

In an aspect, the second sub-section extends obliquely from the first sub-section toward the third sub-section, and an inclination angle of the second sub-section is greater than or equal to 15° and is less than or equal to 60°.

In an aspect, the boss is located between the first end and the second end, and the radial dimension of the boss is further greater than a radial dimension of the second end.

In an aspect, the second-metal layer further includes a fourth section, the fourth section corresponds to a side surface of the boss, and the fourth section is connected to the third section.

In an aspect, along an axial direction of the first-metal post, a distance between an outer surface of the third section and an end of the fourth section facing away from the first end is defined as a, and along a radial direction of the first-metal post, a distance between an outer surface and an inner surface of the fourth section is defined as e, and a>e>0.5 mm.

In an aspect, the second-metal layer further includes a fifth section, the fifth section corresponds to a side surface of the boss away from the first end, and the fourth section connects the fifth section with the third section.

In an aspect, along an axial direction of the first-metal post, a distance between an inner surface of the fifth section and an inner surface of the third section is defined as b, and b>0.5 mm.

In an aspect, along an axial direction of the first-metal post, a distance between an outer surface of the third section and an outer surface of the fifth section is defined as h2; along a radial direction of the first-metal post, a distance between an outer surface of the fourth section and a root on a side of the boss adjacent to the second end is defined as c, and a distance between the outer surface of the fourth section and an end of the fifth section adjacent to a central axial line of the first-metal post is defined as d; c>h2 and d≥⅔c, or c≤h2 and d>0.5 mm.

In an aspect, the fourth section and the fifth section form an inversely-clasping layer wrapping a free end of the boss, and along an axial direction of the first-metal post, a distance between an outer surface of the third section and an outer surface of the inversely-clasping layer is defined as K1, a thickness of the inversely-clasping layer is defined as K2, and f=K2/K1, and f is greater than or equal to 0.3 and is less than 1.

In an aspect, an edge of the end surface of the first end is recessed to form a first stepped portion, and the second-metal layer further includes a second stepped portion, the second stepped portion matches the first stepped portion, the second stepped portion is connected between the first section and the second section, and the second stepped portion is configured to be connected with a tab.

In an aspect, the second stepped portion includes a first step surface and a second step surface connected with each other, a width of the first step surface along a radial direction of the first-metal post is greater than or equal to 0.5 mm, and a height of the second step surface along an axial direction of the first-metal post is greater than or equal to 0.4 mm.

In an aspect, the first-metal post is an aluminum post, and the second-metal layer is a copper layer.

In an aspect, an average thickness of the second-metal layer ranges from 0.1 mm to 3 mm.

In an aspect, an uneven micro-structure is provided at a bonding interface between the second-metal layer and the first-metal post.

In an aspect, a diameter of the conductive structure is less than or equal to 30 mm.

In an aspect of the present disclosure also provide a manufacturing method of a conductive structure, including:
providing a blank material, the blank material including a first layer and a second layer, the first layer including a first metal, and the second layer including a second metal;
placing the blank material in a mold cavity of a first cold heading mold, and keeping the first layer and the second layer sequentially stacked along a direction from the outside to the inside of the mold cavity; and
performing a first cold heading treatment on the blank material, such that when the first layer presses the second layer by means of high-force constraint of the first cold heading mold, the first layer deforms and penetrates into the second layer, and the second layer is thinned and extends toward a peripheral side of the first layer, so as to obtain a semi-finished product; and
performing a first shaping process on the semi-finished product to obtain the conductive structure.

In an aspect, in the blank material, the first layer and the second layer are stacked and bonded together.

In an aspect, in the blank material, a ratio of an average thickness of the second layer to an average thickness of the blank material ranges from 0.1 to 0.2; and/or in the blank material, an edge of the second layer protrudes from an edge of the first layer.

In an aspect, the providing the blank material includes:
providing a composite plate, the composite plate including the first layer and the second layer stacked and bonded together; and
performing die cutting on the composite plate to obtain the blank material.

In an aspect, the manufacturing method of the conductive structure further includes: before placing the blank material in the mold cavity, performing a second shaping process on the blank material; and/or
before placing the blank material in the mold cavity, screening the blank material such that the second layer faces a bottom wall of the mold cavity when the blank material is fed into the mold cavity.

In an aspect, the manufacturing method of the conductive structure further includes: placing the semi-finished product in a second cold heading die, and pressing a side surface of the first layer facing away from the second layer.

In an aspect of the present disclosure also provide a cover plate assembly, including:
a cover plate; and the aforementioned conductive structure or the conductive structure obtained through the manufacturing method mentioned of the conductive structure. The conductive structure is provided penetrating the cover plate.

In an aspect, the conductive structure is a pole, or the conductive structure is a pole and a terminal pressing block integrated with each other; and
the cover plate assembly further includes a current collector, and the current collector is located on a side of the cover plate and welded to the conductive structure.

In an aspect, the cover plate includes:
a cover plate body;
a first insulating member disposed between the conductive structure and the cover plate body; and
a second insulating member disposed between the cover plate body and the current collector. And/or
the cover plate assembly further includes a sealing member, and the sealing member is disposed between the cover plate and the conductive structure.

In an aspect of the present disclosure also provide a battery cell, including:
a shell including an accommodating cavity;
an electrode assembly disposed in the accommodating cavity, the electrode assembly including a tab; and
the aforementioned cover plate assembly. The cover plate assembly is connected to the shell and closes an opening of the accommodating cavity, and the conductive structure is connected to the tab.

Beneficial effects of the examples of the present disclosure are as follows:

In the present disclosure, the second-metal layer bonded to the surface of the first end of the first-metal post is arranged to extend from the surface of the first end of the first-metal post to the second end, that is, an end surface of the first end of the first-metal post and at least part of a side surface of the first-metal post are covered by the second-metal layer. Compared to the form where the second-metal layer is only set on the end surface of one end of the first-metal post, in the present disclosure, a bonding area between the second-metal layer and the first-metal post is effectively increased, the overcurrent capacity of the conductive structure is ensured, the bonding strength between the second-metal layer and the first-metal post is improved, and the risk of the second-metal layer detaching is reduced.

### DESCRIPTION OF THE DRAWINGS

In order to provide clearer explanations of the technical solutions of the present disclosure, it is to be noted that the drawings in the following description are merely some of examples of the present disclosure, and that other drawings may be obtained by the skilled person in the art without involving creative labor.

FIG. 1 is schematic diagram of a front-viewing structure of a first conductive structure provided in examples of the present disclosure.

FIG. 2 is a schematic diagram of a sectional structure of the conductive structure in FIG. 1.

FIG. 3 is an enlarged view of portion A in FIG. 2.

FIG. 4 is a schematic diagram of a front-viewing structure of a second conductive structure provided in examples of the present disclosure.

FIG. 5 is a schematic diagram of a sectional structure of the conductive structure in FIG. 4.

FIG. 6 is a schematic diagram of a three-dimensional structure of a third conductive structure provided in examples of the present disclosure.

FIG. 7 is a schematic diagram of a sectional structure of the conductive structure in FIG. 6.

FIG. 8 is a schematic diagram of a sectional structure of a cover plate assembly formed by assembling the conductive structure in FIG. 6 on a cover plate.

FIG. 9 is an exploded view of the cover plate assembly in FIG. 8.

FIG. 10 is a schematic diagram of a sectional structure of a fourth conductive structure provided in examples of the present disclosure.

FIG. 11 is an enlarged view of portion B in FIG. 10.

FIG. 12 is a schematic diagram of a sectional structure of a fifth conductive structure provided in examples of the present disclosure.

FIG. 13 is an enlarged view of portion C in FIG. 12.

FIG. 14 is a schematic diagram of a sectional structure of a conductive module formed by assembling the conductive structure in FIG. 12 and a terminal pressing block.

FIG. 15 is a schematic diagram of a sectional structure of the terminal pressing block in FIG. 14.

FIG. 16 is a three-dimensional schematic diagram of a sixth conductive structure provided in examples of the present disclosure.

FIG. 17 is a schematic diagram of a sectional structure of the conductive structure in FIG. 16.

FIG. 18 is an exploded view of a cover plate assembly formed by assembling the conductive structure in FIG. 16 on a cover plate.

FIG. 19 is a schematic diagram of a sectional structure of a seventh conductive structure provided in examples of the present disclosure.

FIG. 20 is an enlarged view of portion D in FIG. 19.

FIG. 21 is a schematic diagram of a sectional structure of an eighth conductive structure provided in examples of the present disclosure.

FIG. 22 is an enlarged view of portion E in FIG. 21.

FIG. 23 is a schematic diagram of a sectional structure of a ninth conductive structure provided in examples of the present disclosure.

FIG. 24 is an enlarged view of portion F in FIG. 23.

FIG. 25 is a three-dimensional schematic diagram of a tenth conductive structure provided in examples of the present disclosure from a viewing angle.

FIG. 26 is a three-dimensional schematic diagram of the conductive structure in FIG. 25 from another viewing angle.

FIG. 27 is a schematic diagram of a sectional structure of the conductive structure in FIG. 25.

FIG. 28 is an enlarged view of portion G in FIG. 27.

FIG. 29 to FIG. 30 are flowcharts illustrating manufacturing process of a conductive structure provided in examples of the present disclosure, where FIG. 29 shows schematic perspective views of a sample at different manufacturing stages, and FIG. 30 shows schematic cross-sectional view s of the sample at different manufacturing stages.

FIG. 31 is a schematic diagram of a sectional structure of a battery cell provided in examples of the present disclosure.

Reference numerals are as follows:
10, conductive structure; 101, pole; 102, terminal pressing block;
1, first-metal post;
11, first end; 11, first stepped portion; 11b, groove;
12, second end;
13, boss;
2, second-metal layer;
20, end portion; 201, first extension segment; 202, second extension segment; 20a, gap; 20b, end surface; 20c, transition surface;
203, supporting surface;
2031, inclined surface;
2032, step surface; 20321, first sub-step surface; 20322, second sub-step surface;
21, first section; 211, first sub-section; 212, second sub-section; 213, third sub-section;
22, second section;
23, third section;
24, fourth section;
25, fifth section;
251, inversely-clasping layer;
26, second stepped portion; 261, first step surface; 262, second step surface;
3, blank material; 31, first layer; 32, second layer;
4, semi-finished product;
5, composite plate;
100, cover plate assembly;
110, cover plate; 111, the cover plate body; 112, first insulating member; 113, second insulating member; 114, mounting hole; 115, liquid-injecting hole;
120, current collector;
130, sealing member;
140, explosion-proof valve;
1000, battery cell;
1100, shell; 1110, accommodating cavity;
1200, electrode assembly; 1210, tab.

### DETAILED DESCRIPTION

Technical proposals in examples of the present disclosure will be described clearly and completely below in conjunction with the accompanying drawings in the examples of the present disclosure, and it is apparent that described examples are only some of the examples and not all of the examples of the present disclosure. Based on the examples of the present disclosure, other examples obtained by those skilled in the art without creative work fall within the protection scope of the present disclosure.

In addition, it should be understood that examples described herein are only used to explain and illustrate the present disclosure and are not intended to limit the present disclosure. In the present disclosure, unless otherwise specified, orientational terms used such as “upper” and “lower” usually refer to upper and lower positions of a device in actual use or working state, and orientations in the drawings, while the terms “inside” and “outside” refer to a position relative to an outline of the device.

Terms such as “first” and “second” are used herein for purposes of description, and should not be interpreted as indication or implication of relative importance, or implied indication of a number of the technical features. Thus, features defined by “first” and “second” may explicitly or implicitly include one or more of the features. In the description of the present disclosure, “plurality of” means two or more, unless defined otherwise.

In the description of the present disclosure, it is to be noted that, unless expressly stated and defined otherwise, the terms “install”, “communicate”, and “connect” are to be understood in a broad sense, for example, as a fixed connection, as a detachable connections, or integral connections connection, as an mechanical connection, as an electrical connection, as an communication with each other, as an direct connection, as an indirect connection by means of an intermediate medium, as an internal communication of two elements, or as an interaction of two elements. For those ordinary skilled in the art, the specific meanings of the above terms in the present disclosure can be understood on a case-by-case basis.

The terms “include”, “comprise”, or any of their variations are intended to encompass non-exclusive inclusion, thereby meaning that a process, method, article, or device that includes a series of elements not only includes those elements but also includes other elements not explicitly listed, or elements inherent to such a process, method, article, or device. Without further limitation, an element defined by the statement “comprising a/an” does not exclude the possibility of additional identical elements being present in the process, method, article, or device that includes the said element.

In the description of the present disclosure, words such as “for example” or “such as” are used to indicate illustration, explanation, or description. Any embodiment or design described as “for example” or “such as” in the examples of the present disclosure should not be construed as being preferable or having more advantages compared to another. The use of words “for example”, “such as”, etc. is intended to present relative concepts in a clear manner.

In order to facilitate the understanding of the proposals of the present disclosure, the spline curves and arrows used in the drawings are explained as follows: components indicated by spline curves without arrows are solid components, i.e., components with a solid structure; components indicated by spline curves with arrows are virtual components, i.e., components without a solid structure.

Since a composite pole includes metal layers of different materials, the thermal expansion coefficients of different metals are usually different, resulting in a decrease in the bonding force between the metal layers in the composite pole under high-temperature working conditions, making them prone to separation and detachment. Moreover, the bonding force between the metal layers in the composite pole is affected by a bonding area, and when a diameter of the composite pole is relatively small, the metal layer in the composite pole is also prone to detachment.

In view of the problem of the metal layer in the composite pole easily detaching, leading to the failure of a battery core, the present disclosure provides a conductive structure, a manufacturing method of a conductive structure, a cover plate assembly, and a battery cell.

In an aspect of the present disclosure provide a conductive structure. The conductive structure is configured to connect an internal circuit of a battery cell with a circuit external to the battery cell (referred to as an external circuit for short), thereby enabling communication between the battery cell and the external circuit, which facilitates the external circuit supplying power to the battery cell (i.e., charging the battery cell) or the battery cell supplying power to the external circuit (i.e., discharging the battery cell). The conductive structure may be used to be assembled onto a cover plate of the battery cell.

Referring to FIG. 1 to FIG. 28, the conductive structure 10 includes a first-metal post 1 and a second-metal layer 2, and the second-metal layer 2 is bonded to a surface of the first-metal post 1. The first-metal post 1 has two ends opposite to each other, namely a first end 11 and a second end 12, respectively. The second-metal layer 2 wraps the first end 11 and extends toward the second end 12, and the second-metal layer 2 is configured to connect with a tab.

The conductive structure 10 includes the first-metal post 1 and the second-metal layer 2. It can be understood that the first-metal post 1 is a columnar structure, and a material of the first-metal post 1 includes a first metal. The second-metal layer 2 is a layered structure, and a material of the second-metal layer 2 includes a second metal. The second metal and the first metal are different metals. Optionally, a conductivity of the second metal is greater than a conductivity of the first metal, that is, the conductivity of the second metal is better than the conductivity of the first metal. Optionally, the fluidity of the first metal is greater than the fluidity of the second metal. Optionally, the hardness of the second metal is better than the hardness of the first metal.

The second-metal layer 2 is bonded to the surface of the first-metal post 1, which means that the second-metal layer 2 is located on an outer surface of the first-metal post 1, and the second-metal layer 2 is also bonded to the first-metal post 1. The bonding here means that the second-metal layer 2 and the first-metal post 1 are not separated simply under the action of the gravity. For example, the second-metal layer 2 is physically bonded to the first-metal post 1. As an example, the second-metal layer 2 and the first-metal post 1 may be joined together by cold heading.

It is understood that the second-metal layer 2 wraps a surface of the first end 11, and the second-metal layer 2 extends from the surface of the first end 11 toward the second end 12. The second-metal layer 2 extends from the first end 11 toward the second end 12, an end portion 20 of the second-metal layer 2 extends toward the second end 12, which may mean that the end portion 20 of the second-metal layer 2 extends to the second end 12, or the end portion 20 of the second-metal layer 2 extends to a position between the first end 11 and the second end 12. Optionally, the end portion 20 of the second-metal layer 2 extends to the second end 12, but the second-metal layer 2 does not completely wrap the second end 12, that is to say the second end 12 is at least partially exposed outside the second-metal layer 2 to facilitate a direct connection between the second end 12 and other components. The end portion 20 of the second-metal layer 2 refers to a portion at an edge of the second-metal layer 2. The second-metal layer 2 is configured to connect with the tab. It may either be a direct connection between the second-metal layer 2 and the tab, or the second-metal layer 2 may be connected to the tab through other intermediate components (e.g., a current collector 120). As an example, the second-metal layer 2 is configured to be welded to a current collector 120, and the current collector 120 is welded to the tab. The tab refers to a metal conductor that leads positive and negative electrodes out of a battery cell (i.e., a battery core). As an example, the current collector 120 includes at least one of a current collecting plate and a connecting piece.

When the conductive structure 10 is applied to the battery cell, the first end 11 of the first-metal post 1 faces the inside of the battery cell, and the second end 12 faces the outside of the battery cell. The second-metal layer 2 wraps the first end 11 of the first-metal post 1 and extends from the first end 11 toward the second end 12, so that the second-metal layer 2 can also serve as a protective layer to separate the first end 11 of the first-metal post 1 from the electrolyte in the battery cell, and reduce the risk of the first end 11 being corroded by the electrolyte.

In the conductive structure 10 provided in the present disclosure, the second-metal layer 2 bonded to the surface of the first-metal post 1 is arranged to extend from the surface of the first end 11 of the first-metal post 1 toward the second end 12, that is, an end surface of the first end 11 of the first-metal post 1 and at least part of a side surface of the first-metal post 1 are covered by the second-metal layer 2. Compared to the form where the second-metal layer 2 is only set on the end surface of one end of the first-metal post 1, in the embodiments of the present disclosure, a bonding area between the second-metal layer 2 and the first-metal post 1 is effectively increased, the overcurrent capacity (referred to as the overcurrent capacity) of the conductive structure 10 is ensured, the bonding strength between the second-metal layer 2 and the first-metal post 1 is improved, and the risk of the second-metal layer 2 detaching is reduced.

In addition to increasing the bonding area between the second-metal layer 2 and the first-metal post 1, the second-metal layer 2 is provided so as to extend from the first end 11 of the first-metal post 1 toward the second end 12, thereby shortening a distance between the second-metal layer 2 and the second end 12, and thus shortening a current flow path and improving the overcurrent capability of the conductive structure 10.

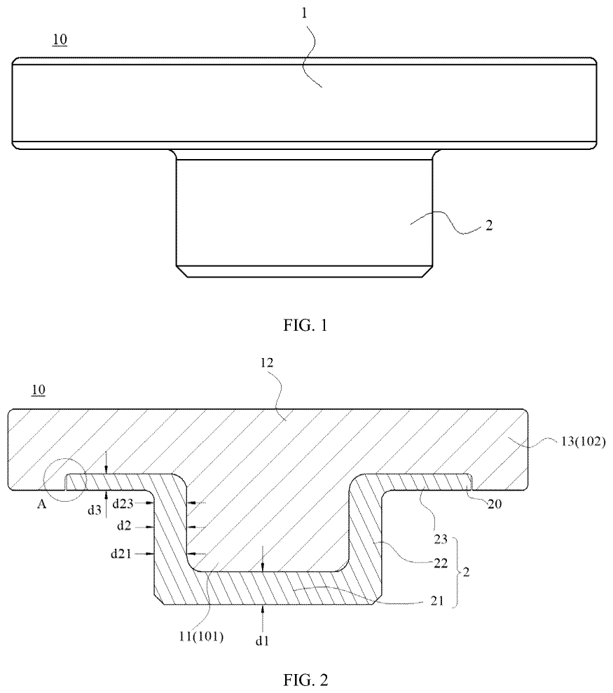

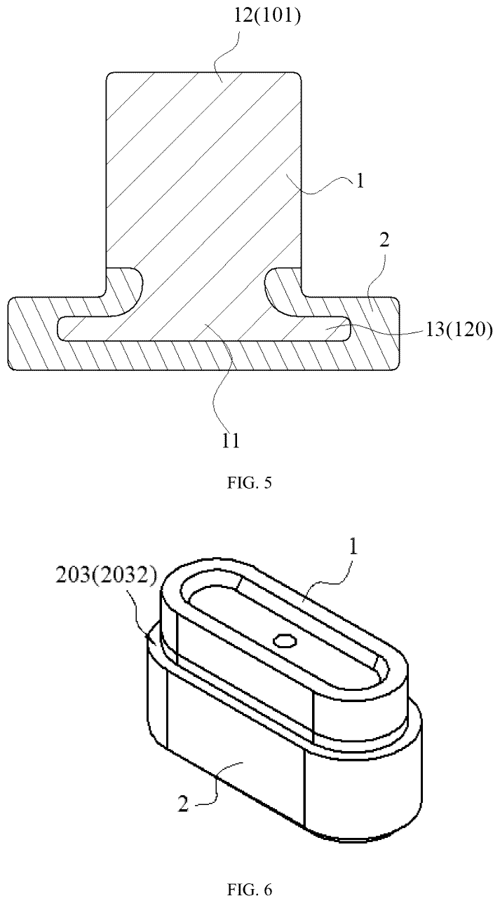

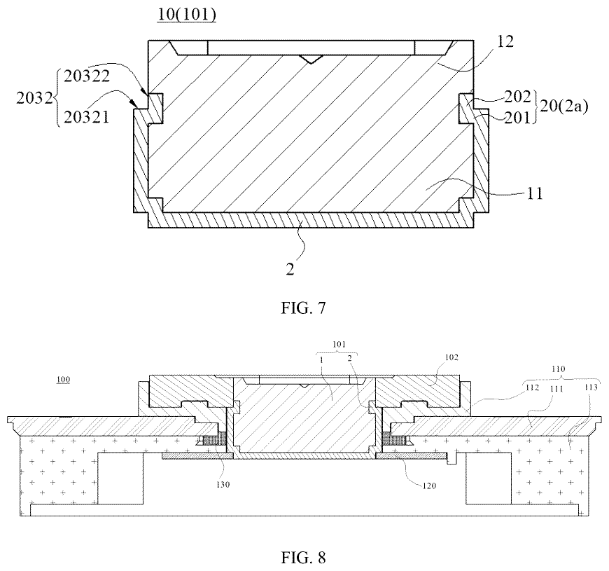

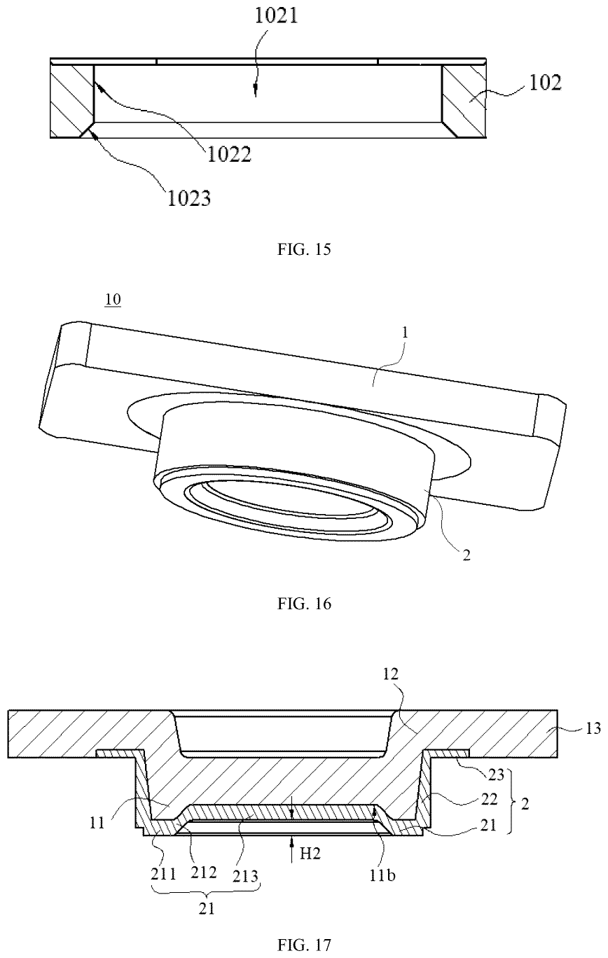

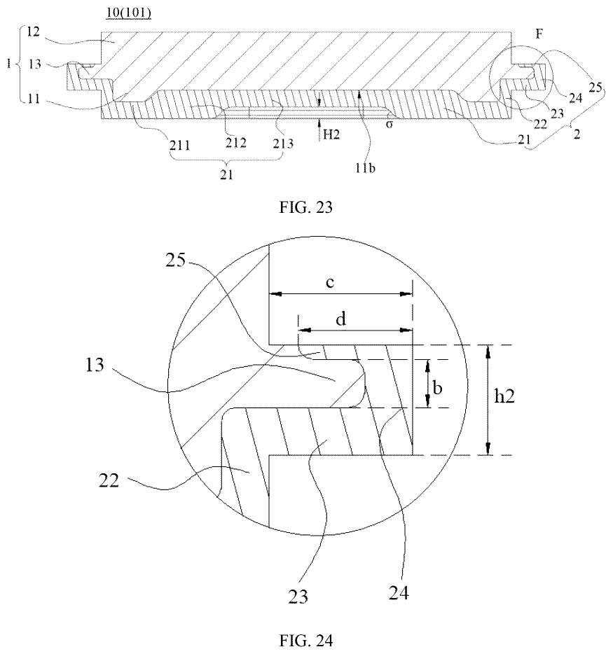

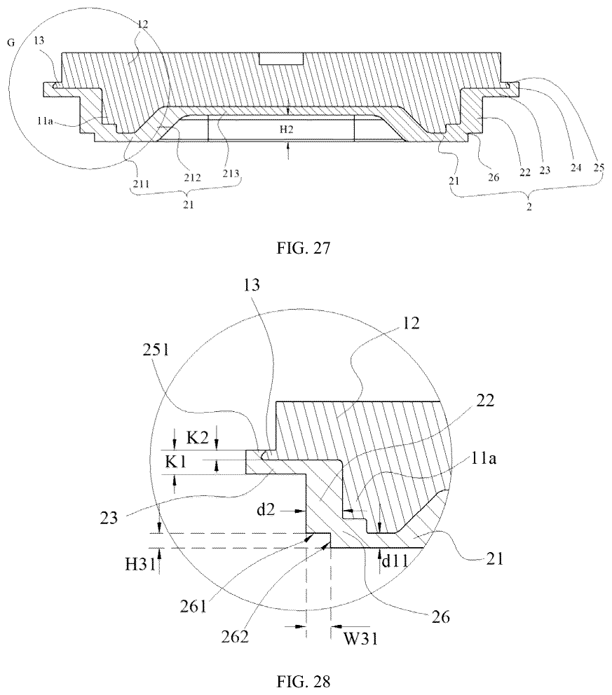

In an aspect, referring to FIG. 2, FIG. 5, FIG. 7, FIG. 10, FIG. 15, FIG. 17, FIG. 19, FIG. 21, FIG. 23, and FIG. 27, the second-metal layer 2 and the first-metal post 1 are cooperated with each other in an embedding manner. It can be that a part of the second-metal layer 2 is embedded in the first-metal post 1, or a part of the first-metal post 1 is embedded in the second-metal layer 2. By matching the second-metal layer 2 and the first-metal post 1 in an embedding manner, the bonding area between the second-metal layer 2 and the first-metal post 1 can be increased to a certain extent, thereby enhancing the overcurrent capability of the conductive structure 10 and reducing the risk of separation between the second-metal layer 2 and the first-metal post 1.

In an aspect, referring to FIG. 2, FIG. 5, FIG. 7, FIG. 10, FIG. 15, FIG. 17, and FIG. 19, the end portion 20 of the second-metal layer 2 is embedded in the first-metal post 1. Since the bonding between the end portion 20 of the second-metal layer 2 and the first-metal post 1 is usually easy to form a weak point, by embedding the end portion 20 of the second-metal layer 2 in the first-metal post 1, the bonding area between the end portion 20 of the second-metal layer 2 and the first-metal post 1 is increased, thereby improving the overcurrent capacity and enhancing the bonding strength. In addition, the end portion 20 of the second-metal layer 2 is hidden in the first-metal post 1, an external force is less likely to scrape the end portion 20 of the second-metal layer 2, thereby reducing the risk of the second-metal layer 2 detaching. The end portion 20 of the second-metal layer 2 is embedded in the first-metal post 1, which may mean that the end portion 20 of the second-metal layer 2 is partially embedded in the first-metal post 1, or the end portion 20 of the second-metal layer 2 is entirely embedded in the first-metal post 1.

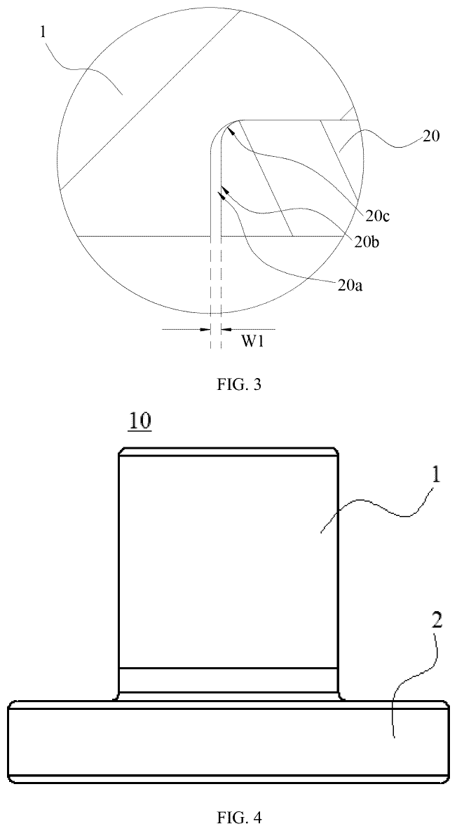

In an aspect, referring to FIG. 2 and FIG. 3, there is a gap 20a between the end portion 20 of the second-metal layer 2 and the first-metal post 1. Since the material of the first-metal post 1 is the first metal, the material of the second-metal layer 2 is the second metal, the first metal is different from the second metal, and the thermal expansion coefficients between different metals are different, so that under high-temperature conditions, the gap 20a can provide a buffer space for the one with a larger volume expansion of the first-metal post 1 and the second-metal layer 2, and a tight fit between the end portion 20 of the first-metal post 1 and the second-metal layer 2 is ensured, thereby reducing the risk of the second-metal layer 2 being separated from the first-metal post 1 due to volume expansion.

In an aspect, referring to FIG. 3, an average dimension W1 of the gap 20a between the end portion 20 of the second-metal layer 2 and the first-metal post 1 is less than 0.1 mm. The average dimension W1 refers to an average distance between the end portion 20 of the second-metal layer 2 and the first-metal post 1. The average dimension W1 should not be too large, otherwise the bonding effect of the first-metal post 1 and the second-metal layer 2 may be affected, and it is difficult to achieve tightness between the end portions 20 of the first-metal post 1 and the second-metal layer 2 at high temperatures. As an example, W1 may be 0.01 mm, 0.02 mm, 0.03 mm, 0.04 mm, 0.05 mm, 0.06 mm, 0.07 mm, 0.08 mm, 0.09 mm, or 0.1 mm.

In an aspect, referring to FIG. 3, an end surface 20b and a transition surface 20c are formed on the end portion 20 of the second-metal layer 2, and the end surface 20b and the transition surface 20c are sequentially connected. Between the second-metal layer 2 and the first-metal post 1, the gap 20a is formed only between the end surface 20b and the transition surface 20c and the first-metal post 1. A side of the end surface 20b away from the transition surface 20c is connected to an outer surface of the second-metal layer 2, and the transition surface 20c is curved and transitioned from the end surface 20b onto the first-metal post 1. The outer surface of the second-metal layer 2 refers to the surface of the second-metal layer 2 exposed outside, and typically the outer surface of the second-metal layer 2 faces away from the first-metal post 1. As an example, the transition surface 20c is an arc-shaped curved surface, and a distance between the transition surface 20c and the first-metal post 1 decreases in a direction approaching the first-metal post 1. By forming the gap 20a only between the end surface 20b and the transition surface 20c and the first-metal post 1, the bonding area between the second-metal layer 2 and the first-metal post 1 is ensured.

In an aspect, the end portion 20 of the second-metal layer 2 may also be disposed so as not to be embedded in the first-metal post 1.

In an aspect, referring to FIG. 7, the end portion 20 of the second-metal layer 2 includes a first extension segment 201 and/or a second extension segment 202. The first extension segment 201 refers to a portion of the end portion 20 of the second-metal layer 2 extending in a first direction, and the second extension segment 202 refers to a portion of the end portion 20 of the second-metal layer 2 extending in a second direction, where the first direction intersects the second direction. Optionally, the first direction and the second direction are perpendicular to each other. As an example, the first direction is the radial direction of the first-metal post 1, and the second direction is the axial direction of the first-metal post 1. That is, the end portion 20 of the second-metal layer 2 may extend in different directions on the surface or inside the first-metal post 1, may extend linearly, or may extend in a bending manner.

In an aspect, referring to FIG. 6 to FIG. 15, the conductive structure 10 is a pole 101. A supporting surface 203 is formed on the end portion 20 of the second-metal layer 2, and the supporting surface 203 is configured to support a terminal pressing block 102. That is, the pole 101 and the terminal pressing block 102 are provided separately. Both the pole 101 and the terminal pressing block 102 are components in the battery cell. The pole 101 is usually partially located inside the battery cell and connected to an electrode assembly, and partially located outside the battery cell, and the terminal pressing block 102 is located outside the battery cell and connected to the pole 101. The terminal pressing block 102 fixes the pole 101 to the cover plate 110, and the terminal pressing block 102 can also be configured to be electrical connected with an external structure, for example, the terminal pressing block 102 is connected to a module bus bar. The end portion 20 of the second-metal layer 2 is provided with the supporting surface 203, and the supporting surface 203 is configured to support the terminal pressing block 102. The supporting surface 203 is connected to an outer side surface of the second-metal layer 2, and the outer surface of the second-metal layer 2 includes the outer side surface of the second-metal layer 2 and the supporting surface 203, that is, the supporting surface 203 is a part of the outer surface of the second-metal layer 2. Optionally, the supporting surface 203 may be at least one of a step surface, a flat surface, and an arc surface. When the pole 101 is connected to the terminal pressing block 102, the terminal pressing block 102 is supported on the supporting surface 203. When the gap between the pole 101 and the terminal pressing block 102 is welded by laser welding, the supporting surface 203 may serve as a bottom surface of the gap and block the laser light during welding, thereby reducing the risk of laser penetration.

In an aspect, referring to FIG. 12 to FIG. 15, the supporting surface 203 is an inclined surface 2031, and in a direction away from the first end 11, the inclined surface 2031 gradually approaches an outer side surface of the first-metal post 1 from the outer side surface of second-metal layer 2. The inclined surface 2031 may be an inclined flat surface or an inclined curved surface. As an example, the inclined curved surface is an inclined arc surface, where the inclined arc surface may be an arc surface that arches in a direction away from the second-metal layer 2, and the inclined arc surface may be an arc surface that sinks in a direction towards the second-metal layer 2. By setting the supporting surface 203 as the inclined surface 2031, and by having the inclined surface 2031 gradually approach the first-metal post 1 in the direction away from the first end 11, the terminal pressing block 102, when supported on the inclined surface 2031, may generate an inward-pressing sub-force along a radial direction of the pole 101 on the inclined surface 2031. This causes the end portion 20 of the second-metal layer 2 to adhere more closely to the first-metal post 1, thereby reducing the risk of detachment of the second-metal layer 2.

In an aspect, referring to FIG. 13, the inclined surface 2031 is an inclined flat surface, and an included angle α between the inclined flat surface and the outer side surface of the second-metal layer 2 ranges from 110° to 130°. The included angle α within the aforementioned range allows the second-metal layer 2 and the first-metal post 1 to form a deformed interlocking bonding interface under the action of the inward-pressing sub-force along the radial direction and applied by the terminal pressing block 102, thereby enhancing the bonding effect between the second-metal layer 2 and the first-metal post 1. As an example, the included angle α may be 110°, 115°, 120°, 125°, or 130°.

In an aspect, referring to FIG. 6 to FIG. 11, the supporting surface 203 is a step surface 2032, and the step surface 2032 includes a first sub-step surface 20321 and a second sub-step surface 20322 connected in sequence. The first sub-step surface 20321 refers to a surface extending in a first direction, and the second sub-step surface 20322 refers to a surface extending in a second direction, where the first direction intersects the second direction. Optionally, the first direction and the second direction are perpendicular to each other. As an example, the first direction is the radial direction of the first-metal post 1, and the second direction is the axial direction of the first-metal post 1. Optionally, the second sub-step surface 20322 and the first sub-step surface 20321 are both flat surfaces. A number of the second sub-step surfaces 20322 is greater than or equal to 1, and a number of the first sub-step surfaces 20321 is greater than or equal to 1. In other words, the number of the second sub-step surface 20322 may be one or a plurality, and the number of the first sub-step surface 20321 may be one or a plurality. Here, a plurality refers to two or more. When the number of the second sub-step surfaces 20322 is one and the number of the first sub-step surfaces 20321 is also one, the obtained step surface 2032 is a single-step surface. When the number of at least one of the second sub-step surface 20322 and the first sub-step surface 20321 is a plurality, the obtained step surface 2032 is a multi-step surface. As an example, the number of the second sub-step surfaces 20322 is two, and the number of the first sub-step surfaces 20321 is also two. In the single-step surface, the second sub-step surface 20322 and the first sub-step surface 20321 are sequentially connected to each other. In the multi-step surface, the second sub-step surfaces 20322 and the first sub-step surfaces 20321 are alternately connected in sequence. By setting the supporting surface 203 as the step surface 2032, the stability of the fit between the terminal pressing block 102 and the pole 101 can be improved, and the risk of laser penetration during laser welding can be reduced.

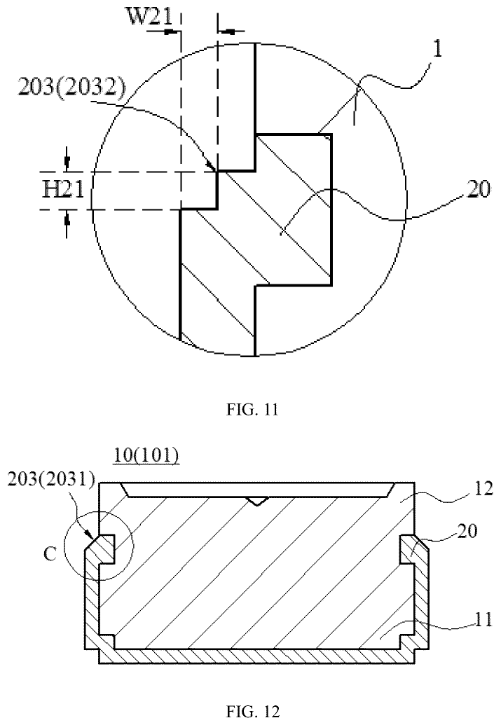

In an aspect, referring to FIG. 11, in a radial direction of the pole 101, a width W21 of the first sub-step surface 20321 is greater than or equal to 0.2 mm. The width W21 of the first sub-step surface 20321 is not likely to be too small, otherwise the step surface is difficult to form and the step surface is prone to damage. As an example, the width W21 of the first sub-step surface 20321 is 0.2 mm, 0.3 mm, 0.4 mm, 0.5 mm, 0.6 mm, or 0.7 mm.

In an aspect, referring to FIG. 11, along an axial direction of the pole 101, a height H21 of the second sub-step surface 20322 is greater than or equal to 0.2 mm. The height H21 of the second sub-step surface 20322 is not likely to be too small, otherwise the step surface is difficult to form and the step surface is prone to damage. As an example, the height H21 of the second sub-step surface 20322 is 0.2 mm, 0.3 mm, 0.4 mm, 0.5 mm, 0.6 mm, or 0.7 mm.

In an aspect, referring to FIG. 13, in the radial direction of the pole 101, the width W2 of the supporting surface 203 is greater than or equal to 0.3 mm and is less than or equal to a thickness of the second-metal layer 2. In the radial direction of the pole 101, a maximum value of the width W2 of the supporting surface 203 is limited by the thickness of the second-metal layer 2, but a minimum value of the width W2 of the supporting surface 203 is related to the design of the supporting surface 203, and the minimum value should not be too small, otherwise it may affect the supporting effect of the supporting surface 203 on the terminal pressing block 102, and then affect the effect of the second-metal layer 2 on blocking the laser during laser welding. As an example, the width W2 of the supporting surface 203 is 0.3 mm, 0.4 mm, 0.5 mm, 0.6 mm, 0.8 mm, 1.0 mm, 1.2 mm, 1.5 mm, 1.8 mm, 2.0 mm, 2.2 mm, 2.5 mm, 2.8 mm, or 3.0 mm.

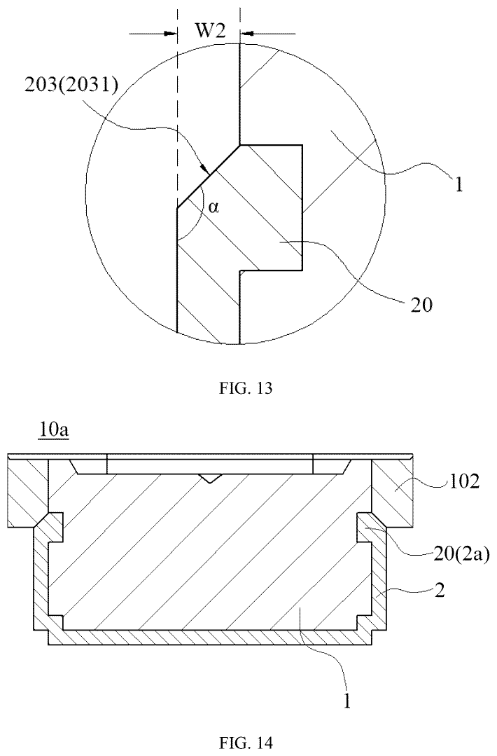

In an aspect, referring to FIG. 14, the conductive structure 10 is a pole 101. The pole 101 and the terminal pressing block 102 are connected to form a conductive module 10a, and the end portion 20 of the second-metal layer 2 is sandwiched between the first-metal post 1 and the terminal pressing block 102. The end portion 20 is formed as a clamping portion 2a, and the clamping portion 2a is sandwiched between the first-metal post 1 and the terminal pressing block 102. That is, a portion of the second-metal layer 2 is sandwiched between the first-metal post 1 and the terminal pressing block 102.

By clamping the portion of the second-metal layer 2 (i.e. the end portion 20) between the first-metal post 1 and the terminal pressing block 102, on the one hand, the first-metal post 1 and the terminal pressing block 102 limit the end portion 20 to prevent the second-metal layer 2 from being separated from the first-metal post 1; on the other hand, due to the ductility of metal, when the first-metal post 1 and the terminal pressing block 102 clamp the end portion 20, the first metal and the second metal mutually penetrate each other, so that the second-metal layer 2 and the first-metal post 1 are more tightly bonded. This dual action jointly reduces the risk of the second-metal layer 2 detaching from the first-metal post 1.

In an aspect, referring to FIG. 15, a through hole 1021 is provided on the terminal pressing block 102, and the terminal pressing block 102 is sleeved on the pole 101 through the through hole 1021. That is, the pole 101 is provided penetrating the terminal pressing block 102 through the through hole 1021. As an example, an end of the pole 101 (e.g., the first end 11 of the first-metal post 1) extends into the through hole 1021, and the terminal pressing block 102 is sleeved on the end of the pole 101. By sleeving the terminal pressing block 102 on the pole 101, a height of the conductive module 10a can be appropriately lowered, and the terminal pressing block 102 can also limit the pole 101.

In an aspect, the terminal pressing block 102 is sleeved on the first-metal post 1 through the through hole 1021. A part of a hole wall 1022 of the through hole 1021 may be in direct contact with the first-metal post 1, or the entire hole wall 1022 of the through hole 1021 may be in direct contact with the first-metal post 1, that is, there is no second-metal layer 2 between the hole wall 1022 of the through hole 1021 and the first-metal post 1. By sleeving the terminal pressing block 102 on the first-metal post 1 through the through hole 1021, it facilitates the terminal pressing block 102 and the first-metal post 1 to be welded, for example, to be welded together by means of laser welding.

In an aspect, the through hole 1021 is in an interference fit with the pole 101. In this way, the tight fit between the terminal pressing block 102 and the pole 101 can be realized, and the thrust resistance and the torsion resistance of the pole 101 can be improved. At the same time, the interference fit mode does not need to introduce other connecting components, making the structure simple and the connection method highly reliable.

In an aspect, the terminal pressing block 102 is riveted and fixed to the pole 101. As an example, the assembly process includes: inserting one end of the pole 101 into the through hole 1021 of the terminal pressing block 102, at which time the pole 101 and the through hole 1021 may be gap fitted, and then riveting the pole 101 and the through hole 1021 together by a press-riveting fixing process. In detail, during the press-riveting fixing process, the pole 101 can be pressed along the axial direction of the pole 101 by using a press-riveting machine, the pole post 101 is deformed during the process of being pressed, and the pole 101 contracts along the axial direction, but the pole 101 expands along the radial direction. At this time, a portion of the pole 101 located in the through hole 1021 fills the gap between the pole 101 and the through hole 1021 and squeeze the hole wall 1022 of the through hole 1021 to realize the interference fit between the pole 101 and the through hole 1021. A portion of the pole 101 located outside the through hole 1021 forms a stopping step fitted with the terminal pressing block 102, that is, the pole 101 is equivalent to a rivet, which improves the reliability of the connection between the terminal pressing block 102 and the pole 101, and reduces the risk of the pole 101 detaching from the terminal pressing block 102. Optionally, during the press-riveting fixing process, the terminal pressing block 102 is fixed by a clamping device, and the terminal pressing block 102 cannot be moved.

In an aspect, referring to FIG. 15, a matching surface 1023 matching the supporting surface 203 is formed on the hole wall 1022 of the through hole 1021. When the supporting surface 203 is the inclined surface 2031, the matching surface 1023 is an inclined matching surface 1023 adapted to the inclined surface 2031. When the supporting surface 203 is the step surface 2032, the matching surface 1023 is the step-matching surface 1023 adapted to the step surface 2032. By utilizing the complementarity between the supporting surface 203 and the matching surface 1023, the stability of the matching between the terminal pressing block 102 and the pole 101 is effectively improved, and the risk of laser penetration during laser welding is reduced. In addition, when the supporting surface 203 is an inclined flat surface, the inclined flat surface being adapted to the matching surface 1023 can also play a guide role, further enhancing the reliability of the matching between the terminal pressing block 102 and the pole 101. In an aspect, the clamping portion 2a is provided in a looped shape, and the clamping portion 2a is connected to a peripheral portion of the first-metal post 1. By providing the clamping portion 2a in the looped shape, a contact area between the clamping portion 2a and a circumferential surface of the first-metal post 1 can be increased, the bonding area between the second-metal layer 2 and the first-metal post 1 can be increased, the risk of the second-metal layer 2 detaching can be reduced, and the manufacturing difficulty of the pole 101 can be effectively reduced. Of course, in other embodiments, the clamping portion 2a may also be configured to include a plurality of protruding pieces, the plurality of protruding pieces are distributed at intervals around the peripheral portion of the first-metal post 1, and the protruding pieces are clamped between the first-metal post 1 and the terminal pressing block 102.

In an aspect, referring to FIG. 1 to FIG. 5 and FIG. 16 to FIG. 28, the first-metal post 1 is radially protruded to form a boss 13, and the second-metal layer 2 extends at least onto the boss 13. The first-metal post 1 locally protrudes outward approximately along the radial direction of the first-metal post 1 to form the boss 13. Optionally, an angular deviation between the boss 13 and the radial direction of the first-metal post 1 is within ±15°. The second-metal layer 2 extends at least onto the boss 13, which may refer to that the end portion 20 of the second-metal layer 2 extends onto the boss 13, or the end portion 20 of the second-metal layer 2 extends beyond the boss 13, i.e., the boss 13 may be completely wrapped in the second-metal layer 2 or partially wrapped in the second-metal layer 2. When the end portion 20 of the second-metal layer 2 extends onto the boss 13, the end portion 20 of the second-metal layer 2 may be embedded in the boss 13 or may be only located on the surface of the boss 13.

As an example, referring to FIG. 2, the boss 13 is away from the first end 11, the end portion 20 of the second-metal layer 2 extends to a side of the boss 13 adjacent to the first end 11, and the end portion 20 of the second-metal layer 2 is embedded in the boss 13.

As an example, referring to FIG. 23, the boss 13 is away from the first end 11, and the end portion 20 of the second-metal layer 2 extends to a side of the boss 13 away from the first end 11.

By making the first-metal post 1 radially protrude to form the boss 13, an area of the outer surface of the first-metal post 1 can be increased by the boss 13, and the second-metal layer 2 also partially or even completely wraps the boss 13, so that the bonding area between the second-metal layer 2 and the first-metal post 1 is increased, thereby enhancing the bonding strength, reducing the risk of the second-metal layer 2 detaching from the first-metal post 1, and simultaneously improving the overcurrent capacity of the conductive structure 10.

In addition, when the conductive structure 10 is applied to a battery cell, the boss 13 can act as a stopping structure in a stopping fit with other components (such as a cover plate 110). At the same time, since the second-metal layer 2 extends at least to the boss 13, the second-metal layer 2 can be clamped between the boss 13 and the component in a stopping fit with the boss 13, thereby reducing the risk of the second-metal layer 2 detaching from the first-metal post 1.

In an aspect, referring to FIG. 4 and FIG. 5, the boss 13 is located at the first end 11, and the boss 13 is completely encased within the second-metal layer 2. As an example, referring to FIG. 5, an outer shape of the conductive structure 10 is roughly a shape of an inverted T. When the conductive structure 10 is assembled to the cover plate 110, the smaller end of the conductive structure 10 can be inserted upward through a mounting hole 114 on the cover plate 110 until the boss 13 comes into contact with the cover plate 110, and the second-metal layer 2 on an upper surface of the boss 13 is clamped between the boss 13 and the cover plate 110 to prevent the second-metal layer 2 from detaching.

In an aspect, referring to FIG. 4 and FIG. 5, the boss 13 is located at the first end 11. The second-metal layer 2 includes a first section and a second section. The first section corresponds to an end surface of the boss 13 (i.e., the first end 11), and the second section 22 covers at least a side surface of the boss 13 and a surface of a side of the boss 13 adjacent to the second end 12, i.e., the boss 13 is completely wrapped in the second-metal layer 2.

In an aspect, referring to FIG. 4 and FIG. 5, the conductive structure 10 is a pole-current collector integrated structure, that is, the conductive structure 10 is a pole 101 and a current collector 120 integrated with each other, and the boss 13 is the current collector 120. By integrating the pole 101 and the current collector 120, the step of assembling the pole 101 and the current collector 120 can be omitted, reducing the production cost of the battery cell. In addition, since the second-metal layer 2 extends to the boss 13, that is, the second-metal layer 2 extends to the current collector 120, it is not necessary to increase the volume of the pole 101, and only by reusing the current collector 120, the bonding area of the second-metal layer 2 can be significantly increased, the risk of the second-metal layer 2 detaching can be reduced, and the overcurrent capacity of the conductive structure 10 can be improved without bringing the burden of volume and weight. The current collector 120 described above is also a component of the battery cell, and the current collector 120 is usually located inside the battery cell. That is, when the pole-current collector integrated structure is assembled on the battery cell, such as on the cover plate 110 of the battery cell, the boss 13 is positioned inside the battery cell. The current collector 120 is also configured to electrically connect with the tab of the electrode assembly.

In an aspect, referring to FIG. 1 to FIG. 3 and FIG. 16 to FIG. 28, the boss 13 is away from the first end 11, and a radial dimension of the boss 13 is greater than a radial dimension of the first end 11. The boss 13 may be located at the second end 12 or may be located between the first end 11 and the second end 12. As an example, referring to FIG. 1, when the boss 13 is located at the second end 12, the outer shape of the conductive structure 10 is roughly a shape of an upright T. When the conductive structure 10 is assembled to the cover plate 110, the smaller end of the conductive structure 10 can be inserted downward through the mounting hole on the cover plate 110 until the boss 13 comes into contact with the cover plate 110, and the second-metal layer 2 on a lower surface of the boss 13 is clamped between the boss 13 and the cover plate 110 to prevent the second-metal layer 2 from detaching.

In an aspect, referring to FIG. 1 to FIG. 3 and FIG. 16 to FIG. 20, the boss 13 is located at the second end 12, and the boss 13 is partially exposed outside the second-metal layer 2. The boss 13 is located at the second end 12. During the assembly of the conductive structure 10 and the cover plate 110, the boss 13 is generally located on an outer side of the cover plate 110. By setting the boss 13 to be partially exposed outside the second-metal layer 2, it facilitates the direct connection of the boss 13 with other components (such as the module bus bars).

In an aspect, the conductive structure 10 is a pole-terminal pressing block integrated structure, that is, the conductive structure 10 is a pole 101 and a terminal pressing block 102 integrated with each other, and the boss 13 is the terminal pressing block 102. By integrating the pole 101 and the terminal pressing block 102, the step of assembling the pole 101 and the terminal pressing block 102 can be omitted, reducing the production cost of the battery cell. In addition, since the second-metal layer 2 extends to the boss 13, that is, the second-metal layer 2 extends to the terminal pressing block 102, it is not necessary to increase the volume of the pole 101, and only by reusing the terminal pressing block 102, the bonding area of the second-metal layer 2 can be significantly increased, the risk of the second-metal layer 2 detaching can be reduced, and the overcurrent capacity of the conductive structure 10 can be improved without bringing the burden of volume and weight. When the pole-terminal pressing block integrated structure is assembled on the battery cell, for example, on the cover plate 110 of the battery cell, the boss 13 is located outside the battery cell.

In an aspect, referring to FIG. 2 and FIG. 16 to FIG. 28, the second-metal layer 2 includes a first section 21, a second section 22, and a third section 23. The first section 21 corresponds to an end surface of the first end 11, the second section 22 corresponds to a side surface of the first end 11, the third section 23 corresponds to a side surface of the boss 13 adjacent to the first end 11, and the second section 22 connects the first section 21 with the third section 23. The first section 21, the second section 22, and the third section 23 refer to three different portions of the second-metal layer 2. The end portion 20 of the second-metal layer 2 may be located in the third section 23, or may not be located in the third section 23. When the end portion 20 of the second-metal layer 2 is not located in the third section 23, it is meant that the second-metal layer 2 also includes other sections, i.e. other portions. Optionally, a number of sections of the second-metal layer 2 is less than or equal to five, as more sections lead to greater manufacturing difficulty and higher costs.

By setting the second-metal layer 2 to include at least three sections, the first section 21 and the second section 22 can wrap the first end 11 to protect the first end 11, and the risk of the first end 11 being corroded by the electrolyte is reduced. The third section 23 extends to the surface of the boss 13, which can further increase the bonding area of the second-metal layer 2, improve the overcurrent capacity of the conductive structure 10, and reduce the risk of the second-metal layer 2 detaching.

In an aspect, referring to FIG. 2, FIG. 17, and FIG. 19, the third section 23 is formed as the end portion 20 of the second-metal layer 2, and the third section 23 is embedded in the boss 13. By setting the second-metal layer 2 to include only three sections, the manufacturing difficulty of the conductive structure 10 can be reduced. At the same time, the third section 23, which serves as the end portion 20 of the second-metal layer 2, is also embedded in the boss 13, thereby increasing the bonding area and ensuring the bonding strength of the second-metal layer 2. This allows the conductive structure 10 to achieve a higher cost performance. In addition, in this way, under high-temperature conditions, when the third section 23 expands, the first-metal post 1 can limit the third section 23 from both ends of the third section 23, allowing the third section 23 to better achieve a tight fit with the first-metal post 1 and enhancing the bonding strength of the second-metal layer 2.

In an aspect, referring to FIG. 2, an average thickness d1 of the first section 21 is greater than an average thickness d2 of the second section 22, and the average thickness d2 of the second section 22 is greater than an average thickness d3 of the third section 23. That is, the first section 21, the second section 22, and the third section 23 satisfy the following thickness relationship: d1>d2>d3. When the conductive structure 10 is applied to the battery cell 1000, the first end 11 of the first-metal post 1 is oriented towards the interior of the battery cell 1000. In terms of the probability of contacting the electrolyte, the probability of the first section 21 is greater than the probability of the second section 22, and the probability of the second section 22 is greater than the probability of the third section 23. By setting the first section 21, the second section 22, and the third section 23 so that the average thickness of the first section 21, the average thickness of the second section 22, and the average thickness of the third section 23 to decrease sequentially, the risk of the first end 11 being corroded by the electrolyte can be reduced while controlling costs.

In an aspect, referring to FIG. 2, the average thickness d2 of the second section 22 is greater than half of the average thickness d1 of the first section 21. Within this range, the second-metal layer 2 has both mechanical strength and cost advantages. As an example, a ratio of d2 to d1 is 0.5, 0.6, 0.7, 0.8, or 0.9.

In an aspect, referring to FIG. 2, the average thickness d3 of the third section 23 is greater than half of the average thickness d2 of the second section 22. Within this range, the second-metal layer 2 has both mechanical strength and cost advantages. As an example, a ratio of d3 to d2 is 0.5, 0.6, 0.7, 0.8, or 0.9.

In an aspect, referring to FIG. 2, a thickness d23 of a portion of the second section 22 adjacent to the third section 23 is greater than a thickness d21 of a portion of the second section adjacent 22 adjacent to the first section 21. In this way, the portion of the second section 22 adjacent to the third section 23, can function as a reverse lock, enhancing the bonding strength between the second-metal layer 2 and the first metal column 1 at this position.

In an aspect, referring to FIG. 17 and FIG. 21 to FIG. 28, the end surface of the first end 11 is locally recessed to form a groove 11b. The first section 21 includes a first sub-section 211, a second sub-section 212, and a third sub-section 213 connected in sequence. The first sub-section 211 is located outside the groove 11b, the second sub-section 212 is located on a sidewall of the groove 11b, and the third sub-section 213 is located on a bottom wall of the groove 11b. The “recessed” here refers to “recessed toward the interior of the first-metal post 1”. The end surface of the first end 11 forms the groove 11b, and the second-metal layer 2 also matches the surface of the first end 11 to form the second sub-section 212 and the third sub-section 213 that fit the inner wall surface of the groove 11b. By providing the groove 11b on the end surface of the first end 11, and attaching the second-metal layer 2 to the inner wall surface of the groove 11b, the bonding area between the second-metal layer 2 and the first-metal post 1 is increased, and the bonding strength is improved.

In an aspect, referring to FIG. 28, the average thickness d2 of the second section 22 is greater than or equal to 0.5 mm. Generally, the greater the average thickness d2 of the second section 22, the higher the mechanical strength of the second section 22, and the better the corrosion resistance and fracture resistance. As an example, the average thickness d2 of the second section 22 is 0.5 mm, 0.6 mm, 0.8 mm, 1.0 mm, 1.2 mm, 1.5 mm, 1.6 mm, 1.8 mm, 2.0 mm, 2.2 mm, 2.4 mm, or 2.5 mm.

In an aspect, referring to FIG. 28, an average thickness d11 of the first sub-section 211 is greater than or equal to 0.5 mm. Generally, the greater the average thickness of the first sub-section 211, the higher the mechanical strength of the first sub-section 211, and the better the corrosion resistance and fracture resistance. As an example, the average thickness d11 of the first sub-section 211 is 0.5 mm, 0.6 mm, 0.8 mm, 1.0 mm, 1.2 mm, 1.5 mm, 1.6 mm, 1.8 mm, 2.0 mm, 2.2 mm, 2.4 mm, or 2.5 mm.

In an aspect, referring to FIG. 17, FIG. 21, FIG. 23, and FIG. 27, a vertical distance H2 between an outer surface of the first sub-section 211 and an outer surface of the third sub-section 213 is less than or equal to 2.5 mm. As an example, H2 is 0.2 mm, 0.5 mm, 0.8 mm, 1.0 mm, 1.2 mm, 1.5 mm, 1.6 mm, 1.8 mm, 2.0 mm, 2.2 mm, 2.4 mm, or 2.5 mm. The vertical distance H2 between the outer surface of the first sub-section 211 and the outer surface of the third sub-section 213 within the aforementioned range can ensure better bonding strength between the first metal column 1 and the second-metal layer 2, while maintaining a low manufacturing difficulty for the conductive structure 10.

In an aspect, referring to FIG. 21 and FIG. 23, the second sub-section 212 extends obliquely from the first sub-section 211 toward the third sub-section 213, and an inclination angle σ of the second sub-section 212 satisfies the following condition: 15°≤σ≤60°. Here, the inclination angle σ refers to an inclination angle of the second sub-section 212 relative to a plane extending in the radial direction of the first-metal post 1. As an example, the inclination angle σ is 15°, 20°, 25°, 30°, 35°, 40°, 45°, 50°, 55°, or 60°. By controlling the inclination angle σ of the second sub-section 212, the second sub-section 212 can smoothly transition from the first sub-section 211 to the third sub-section 213, alleviating the phenomenon that the second-metal layer 2 is broken due to stress concentration at the connection between the second sub-section 212 and the first sub-section 211 and the connection between the second sub-section 212 and the third sub-section 213.

In an aspect, referring to FIG. 21 to FIG. 28, the boss 13 is located between the first end 11 and the second end 12, and the radial dimension of the boss 13 is further greater than a radial dimension of the second end 12. As an example, referring to FIG. 21 and FIG. 23, when the boss 13 is located between the first end 11 and the second end 12, the outer shape of the conductive structure 10 is roughly a shape of the Chinese character “□”. For the conductive structure 10 of this shape, when the boss 13 is used as the stopping structure, the boss 13 can be clamped from both sides of the boss 13, achieving a more stable fixation of the second-metal layer 2. Generally, in order to prevent the conductive structure 10 from being too high, the boss 13 is optionally made thinner, while the second end 12 is configured to electrically connect with other components.

In an aspect, referring to FIG. 21 to FIG. 28, the second-metal layer 2 further includes a fourth section 24, the fourth section 24 corresponds to the side surface of the boss 13, the fourth section 24 is connected to the third section 23. The arrangement of the fourth section 24 may further increase the bonding area of the second-metal layer 2 and the first-metal post 1. Here, the side surface of the boss 13 may be completely covered by the fourth section 24, or may be partially covered by the fourth section 24.

In an aspect, referring to FIG. 22, along the axial direction of the first-metal post 1, a distance between an outer surface of the third section 23 and an end of the fourth section 24 facing away from the first end 11 is defined as a; and along the radial direction of the first-metal post 1, a distance between an outer surface and an inner surface of the fourth section 24 is defined as e, where a>e>0.5 mm. Within this range, the bonding area between the fourth section 24 and the boss 13 is relatively large, and the strength of the fourth section 24 itself is also relatively large, which not only improves the overcurrent capacity of the conductive structure 10, but also improves the bonding strength between the second-metal layer 2 and the first-metal post 1. In the axial direction of the first-metal post 1, the distance between the outer surface of the third section 23 and the outer surface of the boss 13 is defined as h1.

In an aspect, referring to FIG. 23 to FIG. 28, the second-metal layer 2 further includes a fifth section 25, the fifth section 25 corresponds to the surface of the side the boss 13 away from the first end 11, and the fourth section 24 connects the fifth section 25 with the third section 23. The arrangement of the fifth section 25 may further increase the bonding area between the second-metal layer 2 and the first-metal post 1. Optionally, the end portion 20 of the second-metal layer 2 is located in the fifth section 25.

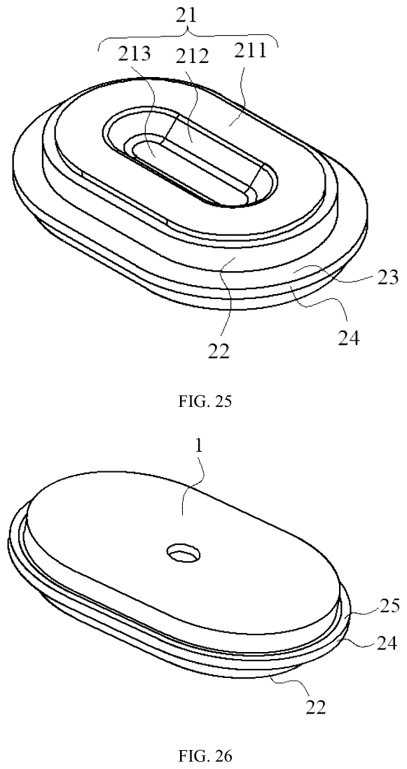

In an aspect, referring to FIG. 24, along the axial direction of the first-metal post 1, a distance between an inner surface of the fifth section 25 and an inner surface of the third section 23 is defined as b, and b>0.5 mm. Since the boss 13 is at least partially located between the inner surface of the fifth section 25 and the inner surface of the third section 23, by setting b>0.5 mm, it is advantageous to ensure the mechanical strength of the boss 13, especially when the boss 13 serves as the stopping structure, the risk of breaking of the boss 13 can be reduced.

In an aspect, referring to FIG. 24, along the axial direction of the first-metal post 1, a distance between the outer surface of the third section 23 and the outer surface of the fifth section 25 is defined as h2; along the radial direction of the first-metal post 1, a distance between the outer surface of the fourth section 24 and a root on the side of the boss 13 adjacent to the second end 12 is defined as c, and a distance between the outer surface of the fourth section 24 and an end of the fifth section 25 adjacent to a central axial line of the first-metal post 1 is defined as d; where c>h2 and d≥⅔c, or c≤h2 and d>0.5 mm. Within the above range, the bonding strength between the second-metal layer 2 and the first-metal post 1 can be effectively improved.

In some embodiment, the fourth section 24 and the fifth section 25 form an inversely-clasping layer 251 wrapping a free end of the boss 13. Along the axial direction of the first-metal post 1, a distance between the outer surface of the third section and an outer surface of the inversely-clasping layer 251 is defined as K1, a thickness of the inversely-clasping layer 251 is defined as K2, and f=K2/K1, where f is greater than or equal to 0.3 and is less than 1. The inversely-clasping layer 251 can enhance the mounting strength of the conductive structure 10.

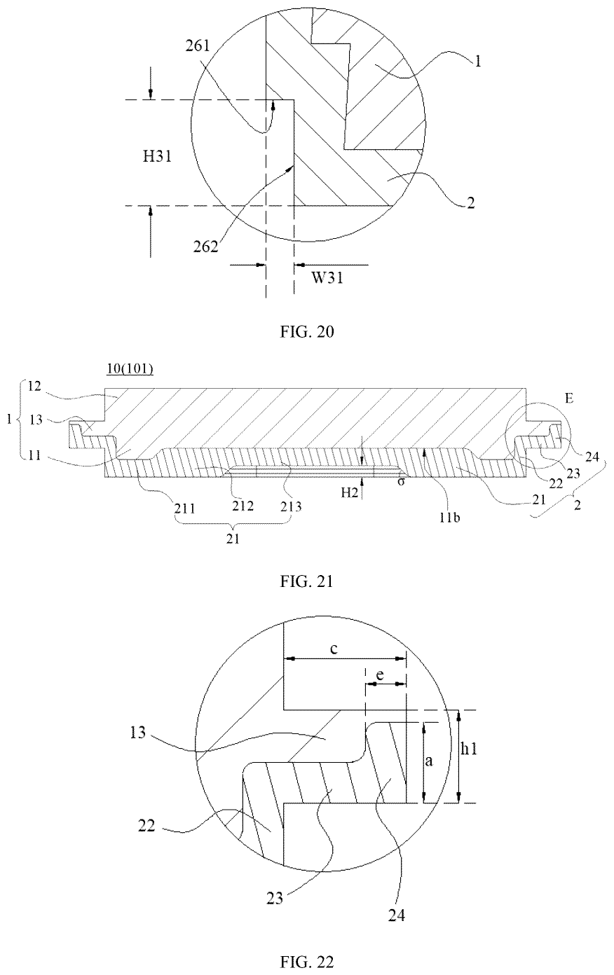

In an aspect, referring to FIG. 19, FIG. 20, and FIG. 25 to FIG. 28, an edge of the end surface of the first end 11 is recessed to form a first stepped portion 11a, the second-metal layer 2 further includes a second stepped portion 26, the second stepped portion 26 matches the first stepped portion 11a, the second stepped portion 26 is connected between the first section 21 and the second section 22, and the second stepped portion 26 is configured to be connected with the tab. It can be foreseen that one end of the conductive structure 10 may also have a step, and the step is formed by stacking the second stepped portion 26 on the first stepped portion 11a, equivalent to the simultaneous inward recess formation of the first-metal post 1 and the second-metal layer 2. The advantage of this arrangement lies in altering the strong correlation between the area of the second stepped portion 26 and the thickness of the second-metal layer 2, allowing the formation of a sufficiently large second stepped portion 26 even if the thickness of the second-metal layer 2 is very small, thereby ensuring the effectiveness of the connection between the second stepped portion 26 and the tab. Optionally, the first stepped portion 11a is a sunk platform located at an edge of the end surface of the first end 11, and the sunk platform is formed by the end surface of the first end 11 being sunken in a direction toward the second end 12. In the second-metal layer 2, the first section 21, the second stepped portion 26, and the second section 22 are connected in sequence. Optionally, the second stepped portion 26 is configured to be welded with the current collector 120 connected to the tab. For example, when welding the second stepped portion 26 and the current collector 120, the current collector 120 may first be sleeved on the conductive structure 10, and the current collector 120 and the second stepped portion 26 may fit with each other, and the current collector 120 may be welded to the second stepped portion 26 by laser welding. The larger the surface area of the second stepped portion 26, the larger the area of a surface of the second stepped portion 26 can be welded to the current collector 120, and the larger the welding surface, the higher the reliability of welding.

In an aspect, referring to FIG. 19, FIG. 20, and FIG. 28, the second stepped portion 26 includes a first step surface 261 and a second step surface 262 connected with each other. The second stepped portion 26 has an L-shape, the first step surface 261 is a surface on the second stepped portion 26 extending in a first direction, and the second step surface 262 is a surface on the second stepped portion 26 extending in a second direction. The first direction intersects with the second direction. Optionally, the first direction and the second direction are perpendicular to each other. As an example, the first direction is the radial direction of the first-metal post 1, and the second direction is the axial direction of the first-metal post 1. In the radial direction of the first-metal post 1, a width W31 of the first step surface 261 is greater than or equal to 0.5 mm. As an example, the width W31 of the first step surface 261 is 0.5 mm, 0.6 mm, 0.7 mm, 0.8 mm, 0.9 mm, or 1.0 mm. In the axial direction of the first-metal post 1, a height H31 of the second step surface 262 is greater than or equal to 0.4 mm. As an example, the height H31 of the second step surface 262 is 0.4 mm, 0.5 mm, 0.6 mm, 0.7 mm, 0.8 mm, 0.9 mm, or 1.0 mm. By increasing the width of the first step surface 261 and the height of the second step surface 262, it can be ensured that the second stepped portion 26 has sufficient contact area, thereby improving the overcurrent capacity and connection strength.

In an aspect, the first metal is aluminum, that is, the first-metal post 1 is an aluminum column. The second metal is copper, that is, the second-metal layer 2 is a copper layer. Compared to copper, aluminum is cheaper. By configuring the conductive structure 10 to include an aluminum column and a copper layer, the costs of the conductive structure 10 can be effectively reduced. For example, the conductive structure 10 is a negative pole.

In an aspect, an average thickness D1 of the second-metal layer 2 is less than or equal to 3 mm. By thinning the second-metal layer 2, the production costs of the conductive structure 10 can be effectively reduced, especially under the condition that the first-metal post 1 is an aluminum column and the second-metal layer 2 is a copper layer, the use of more expensive copper can be reduced, and the weight of the conductive structure 10 can be reduced while effectively reducing the weight of the conductive structure 10. As an example, the average thickness D1 of the second-metal layer 2 is 0.4 mm, 0.5 mm, 0.6 mm, 0.8 mm, 1.0 mm, 1.2 mm, 1.5 mm, 1.8 mm, 2.0 mm, 2.2 mm, 2.5 mm, 2.8 mm, or 3.0 mm. Optionally, the average thickness D1 of the second-metal layer 2 is less than or equal to 1.8 mm.

In an aspect, the average thickness D1 of the second-metal layer 2 ranges from 0.2 mm to 1.5 mm. Generally, when the average thickness D1 of the second-metal layer 2 decreases, the overcurrent capacity of the conductive structure 10 decreases, and the cost of the conductive structure 10 decreases. By designing the average thickness D1 of the second-metal layer 2 to range from 0.2 mm to 1.5 mm, the conductive structure 10 can achieve both cost advantages and sufficient overcurrent capacity within this range. As an example, the average thickness D1 of the second-metal layer 2 is 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, or 1.5 mm.

In an aspect, an uneven micro-structure is provided at the bonding interface between the second-metal layer 2 and the first-metal post 1. This refers to the micro-level where a surface of the second-metal layer 2 fits in a concave-convex manner with a surface of the first-metal post 1. Optionally, the conductive structure 10 is a cold heading forming part. As an example, the first-metal post 1 is an aluminum column, the second-metal layer 2 is a copper layer, and the conductive structure 10 is formed by cold heading from a copper-aluminum composite plate. Since the metal has ductility, during the cold heading process, under the action of pressure, the first metal in the first-metal post 1 and the second metal in the second-metal layer 2 are deformed and mutually penetrate each other, so that the bonding interface between the first-metal post 1 and the second-metal layer 2 is formed into a microscopically uneven wavy surface, so that the bonding area between the first-metal post 1 and the second-metal layer 2 can be further increased, thereby enhancing the bonding strength.

In an aspect, the diameter φ of the conductive structure 10 is less than or equal to 30 mm. The diameter φ of the conductive structure 10 should not be too large, otherwise the weight and cost of the battery cell are increased. Optionally, 5 mm≤φ≤30 mm, within this range, the conductive structure 10 has both better overcurrent capability and cost advantages. As an example, the diameter φ of the conductive structure 10 is 5 mm, 10 mm, 15 mm, 20 mm, 25 mm, or 30 mm.

In an aspect, the diameter φ of the conductive structure 10 is less than or equal to 10 mm. By reducing the size of the conductive structure 10, the production cost of the conductive structure 10 can be effectively reduced. As an example, the diameter φ of the conductive structure 10 is 5 mm, 6 mm, 7 mm, 8 mm, 9 mm, or 10 mm.

In an aspect, in the conductive structure 10, the ratio of the volume of the second-metal layer 2 to the total volume of the conductive structure 10 ranges from 5 vol % to 70 vol %. Within this range, the conductive structure 10 has better bonding strength, better overcurrent capability, and cost advantages. As an example, a volume percentage of the second-metal layer 2 is 5 vol %, 10 vol %, 15 vol %, 20 vol %, 25 vol %, 30 vol %, 35 vol %, 40 vol %, 45 vol %, 50 vol %, 55 vol %, 60 vol %, 65 vol %, or 70 vol %.

In an aspect, in the conductive structure 10, the ratio of the volume of the second-metal layer 2 to the total volume of the conductive structure 10 ranges from 5 vol % to 40 vol %. Within this range, the conductive structure 10 has better bonding strength, better overcurrent capability, and cost advantages. As an example, the volume percentage of the second-metal layer 2 is 5 vol %, 10 vol %, 15 vol %, 20 vol %, 25 vol %, 30 vol %, 35 vol %, or 40 vol %.

In an aspect, the first-metal post 1 is sectioned along the radial direction of the first-metal post 1, and a cross-sectional shape of the first-metal post 1 may be one of square, circular, hexagonal, or racetrack-shaped.

In an aspect, the bonding area between the second-metal layer 2 and the first-metal post 1 is greater than or equal to 20 mm². When the second-metal layer 2 is bonded to the surface of the first-metal post 1, the surface between the second-metal layer 2 and the first-metal post 1 in contact with each other is the bonding interface, also referred to as a contact surface. The bonding area between the second-metal layer 2 and the first-metal post 1 refers to an area of the surface of the second-metal layer 2 in contact with the first-metal post 1. As an example, the bonding area is 20 mm², 30 mm², 40 mm², 50 mm², 100 mm², 150 mm², 200 mm², 300 mm², 400 mm², or 500 mm². By increasing the bonding area, the overcurrent capability of the conductive structure 10 can be improved, and the risk of the second-metal layer 2 detaching can be reduced.

In an aspect, the bonding area between the second-metal layer 2 and the first-metal post 1 is greater than or equal to 80 mm². As an example, the bonding area is 80 mm², 90 mm², 100 mm², 120 mm², 130 mm², 140 mm², 150 mm², 200 mm², 250 mm², 300 mm², 400 mm², or 500 mm².

In an aspect, a volume ratio of the second-metal layer 2 to the first-metal post 1 ranges from 0.1 to 0.65. That is, the volume of the first-metal post 1 is 1.54 to 10 times the volume of the second-metal layer 2, meaning that the volume percentage of the first-metal post 1 in the conductive structure 10 is much greater than the volume percentage of the second-metal layer 2. Under the condition that the bonding area between the second-metal layer 2 and the first-metal post 1 is increased, the conductive structure 10 is ensured to still have sufficient overcurrent capacity, and the cost of the conductive structure 10 can be reduced by reducing the volume percentage of the second-metal layer 2 in the conductive structure 10, especially when the first-metal post 1 is an aluminum column and the second-metal layer 2 is a copper layer. As an example, the volume ratio of the second-metal layer 2 to the first-metal post 1 is 0.1, 0.2, 0.3, 0.4, 0.5, 0.6, or 0.65. Generally, the volume ratio of the second-metal layer 2 to the first-metal post 1 fluctuates following the size (e.g. diameter) of the conductive structure 10, and the larger the size of the conductive structure 10, the smaller the volume ratio of the second-metal layer 2 to the first-metal post 1.

In an aspect, referring to FIG. 2, on an appearance surface of the conductive structure 10, a ratio A of the surface area of the second-metal layer 2 to the surface area of the first-metal post 1 is greater than or equal to 0.25. Since the second-metal layer 2 is bonded to the surface of the first-metal post 1, the exposed surface of the second-metal layer 2 is formed as the appearance surface of the conductive structure 10. When the second-metal layer 2 is not completely covered on the first-metal post 1, the exposed surface of the first-metal post 1 may also form the appearance surface of the conductive structure 10. It can be understood that, on the appearance surface of the conductive structure 10, the surface area of the second-metal layer 2 is the area of the exposed surface of the second-metal layer 2, and the surface area of the first-metal post 1 is the area of the exposed surface of the first-metal post 1. Increasing the surface area of the second-metal layer 2 on the appearance surface of the conductive structure 10 is equivalent to increasing the area of the second-metal layer 2 covering on the first-metal post 1, that is, increasing the bonding area between the second-metal layer 2 and the first-metal post 1. As an example, on the appearance surface of the conductive structure 10, the ratio A of the surface area of the second-metal layer 2 to the surface area of the first-metal post 1 is 0.25, 0.5, 0.75, 1, 1.5, 2, 2.5, or 3.

In an aspect, the diameter φ of the conductive structure 10 is less than or equal to 10 mm, and the ratio A of the surface area of the second-metal layer 2 to the surface area of the first-metal post 1 is greater than or equal to 0.25 and is less than or equal to 0.6. In order to facilitate direct connection of the second end 12 with other components, the second end 12 is at least partially exposed outside the second-metal layer 2. Generally, the smaller the diameter of the conductive structure 10, the smaller the surface area of the conductive structure 10. Under the condition that φ≤10 mm, controlling 0.25≤A≤0.6 can ensure that the second end 12 has sufficient connection surface to connect with other components, and the bonding area is sufficiently large, thereby ensuring the overcurrent capacity of the conductive structure 10. As an example, φ is 5 mm, 6 mm, 7 mm, 8 mm, 9 mm, or 10 mm, and A is 0.25, 0.3, 0.4, 0.5, or 0.6.

In an aspect, the diameter φ of the conductive structure 10 is greater than 10 mm and is less than or equal to 30 mm, and the ratio of the surface area of the second-metal layer 2 to the surface area of the first-metal post 1 is greater than or equal to 0.75 and is less than or equal to 2. When the diameter of the conductive structure 10 increases, the overcurrent capacity of the conductive structure 10 is improved, but the cost of the conductive structure 10 is increased and the volume and quality burden are imposed. Under the condition that 10 mm<φ≤30 mm, the conductive structure 10 can have both cost advantages and better overcurrent capability. In addition, as the diameter of the conductive structure 10 increases, the surface area of the conductive structure 10 also increases, and the second end 12 remains partially exposed outside the second-metal layer 2, and other regions can be covered with the second-metal layer 2 to increase the bonding area. Under the condition that 10 mm<φ≤30 mm, controlling 0.75≤A≤2 can ensure that the bonding area is sufficiently large, thereby ensuring the overcurrent capacity of the conductive structure 10. As an example, φ is 10.1 mm, 11 mm, 12 mm, 14 mm, 16 mm, 18 mm, 20 mm, 22 mm, 24 mm, 26 mm, 28 mm, or 30 mm, and A is 0.75, 0.8, 0.9, 1.0, 1.2, 1.5, 1.7, 1.85, or 2.

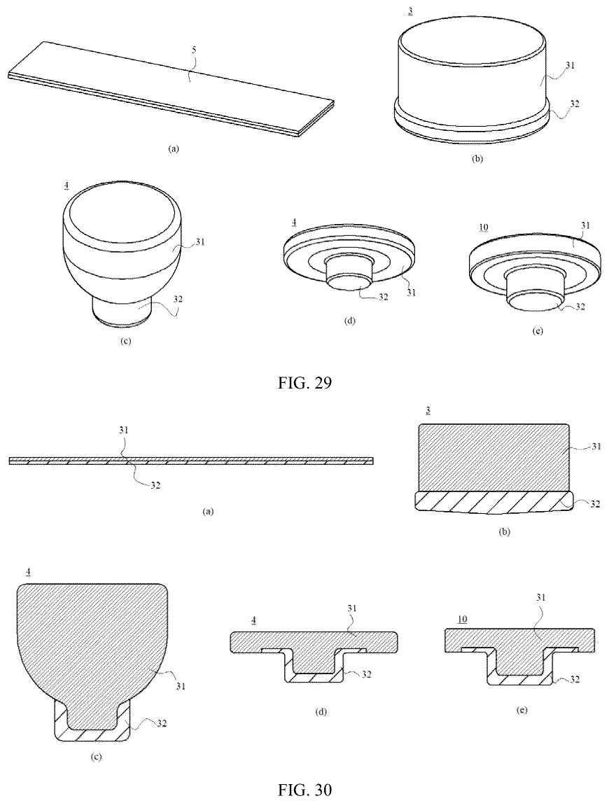

In a second aspect, embodiments the present disclosure also provide a manufacturing method of a conductive structure 10. Referring to FIG. 29 and FIG. 30, the manufacturing method of the conductive structure 10 includes:
S10, providing a blank material 3, the blank material 3 including a first layer 31 and a second layer 32, the first layer 31 including a first metal, and the second layer 32 including a second metal;
S20, placing the blank material 3 in a mold cavity of a first cold heading mold, and keeping the first layer 31 and the second layer 32 sequentially stacked along a direction from the outside to the inside of the mold cavity;

S30, performing a first cold heading treatment on the blank material 3, such that when the first layer 31 presses the second layer 32 by means of high-force constraint of the first cold heading mold, the first layer 31 deforms and penetrates into the second layer 32, and the second layer 32 is thinned and extends toward a peripheral side of the first layer 31, so as to obtain a semi-finished product 4; and
S40, performing a first shaping process on the semi-finished product 4 to obtain the conductive structure 10.

The blank material 3 includes the first layer 31 and the second layer 32. The first layer 31 includes the first metal, that is, the first layer 31 is a metal layer, and the material of the first layer 31 is the first metal. The second layer 32 includes the second metal, that is, the second layer 32 is also a metal layer, and the material of the second layer 32 is the second metal. The first metal is different from the second metal. As an example, the first metal is aluminum, and the second metal is copper. Optionally, the first layer 31 and the second layer 32 in the blank material 3 are stacked or laminated together. Of course, under some conditions, the first layer 31 and the second layer 32 in the blank material 3 may also be separable, since the subsequent first cold heading process may also cause the first layer 31 and the second layer 32 to be bonded together, and therefore the first layer 31 and the second layer 32 are not necessarily required to be bonded together in the blank material 3.

The first cold heading mold includes a mold cavity, and the blank material 3 is placed in the mold cavity. Along the direction from the outside to the inside of the mold cavity, the first layer 31 and the second layer 32 are kept stacked sequentially, that is, the second layer 32 is closer to a bottom wall of the mold cavity than the first layer 31, and the first layer 31 is closer to an opening of the mold cavity than the second layer 32. When the blank material 3 is placed in the mold cavity, the blank material 3 may be completely accommodated in the mold cavity, or one end of the blank material 3 may be inserted into the mold cavity. A portion of the blank material 3 inserted into the mold cavity may be exactly adapted to the size of the mold cavity or may be smaller than the mold cavity. The mold cavity may have different shapes. Generally, the shape of the mold cavity affects a shape of the semi-finished product 4. As an example, when the mold cavity includes a first cavity section and second cavity section communicated with each other. An inner diameter of the first cavity section is less than an inner diameter of the second cavity section, the first cavity section is columnar, and the second cavity section is bowl-shaped. As a result, the semi-finished product 4 appears in the mushroom head shape shown in (c) of FIG. 29 and (c) of FIG. 30.

The first cold heading treatment refers to performing pier pressing on the blank material 3. For example, a punch of a cold heading machine is used to stamp the blank material 3. Since when the blank material 3 is placed in the mold cavity of the first cold heading mold, the second layer 32 of the blank material 3 is oriented towards the inside of the mold cavity, and the first layer 31 of the blank material 3 is oriented towards the outside of the mold cavity, so that the punch of the cold heading machine acts directly on the first layer 31, i.e. presses the blank material 3 from a side surface of the first layer 31 facing away from the second layer 32. Since both the first layer 31 and the second layer 32 are metal layers, and metal has ductility, when the blank material 3 is subjected by pier pressing, the first layer and 31 the second layer 32 are deformed and stretched. For example, when the blank material 3 is subjected by pier pressing in an axial direction of the blank material 3, the first layer 31 and the second layer 32 are stretched in a radial direction of the blank material 3.

Since the blank material 3 is placed in the mold cavity of the first cold heading mold, the first cold heading mold, a high-force constraint action applied by a sidewall of the mold cavity on the blank material 3, which is referred to as high-force constraint for short, regulates the direction in which the first layer 31 and the second layer 32 are deformed and stretched. Therefore, the first cold heading treatment may also be referred to as high-force constraint processing or cold heading forming. Generally, a thickness of the sidewall of the mold cavity in the first cold heading mold, the material of the first cold heading mold, etc. may affect the high-force constraint of the first cold heading mold. As an example, the first cold heading mold is a stainless steel mold.

Referring to (c) of FIG. 29 and (c) of FIG. 30, when the blank material 3 is subjected by pier pressing, since the first layer 31 and the second layer 32 are stacked, the first layer 31 presses the second layer 32. However, due to the high-force constraint of the first cold heading mold, the first layer 31 is deformed and intrudes into the second layer 32 due to the pressure, and the second layer 32 is deformed and thinned due to the pressure and extends to a peripheral side of the first layer 31, i.e. along a tiny gap between the first layer 31 and the sidewall of the mold cavity, to obtain the semi-finished product 4.

In order to improve the dimensional accuracy, shape, surface roughness of the semi-finished product 4, remove excess material, etc., the semi-finished product 4 is continuously subjected 4 to the first shaping process, thereby obtaining the conductive structure 10 satisfying the requirements, referring to (e) of FIG. 29 and (e) of FIG. 30. The first shaping process includes, but is not limited to, at least one of die cutting, polishing, and grinding.

Optionally, the manufacturing method of the conductive structure 10 is configured to prepare the conductive structure 10 provided in the first aspect. The first layer 31 is deformed by pier pressing to obtain the first-metal post 1, and the second layer 32 is deformed by pier pressing to obtain the second-metal layer 2.

In the manufacturing method of the conductive structure 10 provided in the embodiments of the present disclosure, the first layer 31 and the second layer 323 are bonded together by using cold heading forming, and during the process of cold heading forming, the deformation, extension and intrusion of the first layer 31 and the second layer 32 can make the bonding interface between the first layer 31 and the second layer 32 become a microscopically uneven surface, so that the area of the bonding interface is increased and the bonding strength is enhanced. In addition, during the process of cold heading forming, the second layer 32 extends to the peripheral side of the first layer 31, that is, the second layer 32 is not only bonded to the bottom surface of the first layer 31, but also bonded to the side surface of the first layer 31, further increasing the bonding area of the two and enhancing the bonding strength.

In an aspect, referring to (b) of FIG. 29 and (b) of FIG. 30, in the blank material 3, the first layer 31 and the second layer 32 are stacked together. It can be understood that in the blank material 3, the first layer is 31 located on a side of the second layer 32, and the first layer 31 and the second layer 32 are bonded together. By first stacking and bonding the first layer 31 and the second layer 32, it facilitates feeding both the first layer 31 and the second layer 32 together and placing them into the mold cavity, thereby simplifying the manufacturing process of the conductive structure 10.

In an aspect, in the blank material 3, a ratio of an average thickness of the second layer 32 to an average thickness of the blank material 3 ranges from 0.1 to 0.2. That is, the average thickness of the first layer 31 is much greater than the average thickness of the second layer 32. Generally, the second layer 32 should not be too large, otherwise the second layer 32 is not easily extended, especially when the hardness of the second metal is greater than the hardness of the first metal, the manufacturing difficulty during the first cold heading process increased. The second layer 32 should not be too thin, otherwise the second layer 32 is easily broken during the process of the cold heading forming. As an example, the ratio of the average thickness of the second layer 32 to the average thickness of the blank material 3 is 0.1, 0.11, 0.12, 0.13, 0.14, 0.15, 0.16, 0.17, 0.18, 0.19, or 0.2.

In an aspect, referring to (b) in FIG. 29 and (b) in FIG. 30, in the blank material 3, an edge of the second layer 32 protrudes from an edge of the first layer 31. The edge of the second layer 32 appropriately protrudes from the edge of the first layer 31, so that when the blank material 3 is placed into the mold cavity of the first cold heading mold, a certain gap can be maintained between the side of the first layer 31 and the inner sidewall of the mold cavity, and during the first cold heading process, the existence of the gap can promote the extension to the peripheral side of the first layer 31, thereby reducing the manufacturing difficulty.

In an aspect, referring to (a) in FIG. 29 and (a) in FIG. 30, the providing the blank material 3 includes preparing the blank material 3, and the manufacturing process of the blank material 3 includes:
S11, providing a composite plate 5, the composite plate 5 including the first layer 31 and the second layer 32 stacked and bonded together; and
S12, performing die cutting on the composite plate 5 to obtain the blank material 3.

Optionally, the blank material 3 is columnar. As an example, the first metal is aluminum, and the second metal is copper, the composite plate 5 is a copper-aluminum composite plate, and the copper-aluminum composite plate includes a copper layer and an aluminum layer arranged in a stacking manner. A copper-aluminum composite column, i.e., the blank material 3, can be obtained by die cutting the copper-aluminum composite plate.

By applying the composite plate 5 to obtain the blank material 3, the process is simple and easy to manufacture.

In an aspect, the manufacture method of the conductive structure further includes:
S13, performing a second shaping process on the blank material 3 before placing the blank material 3 in the mold cavity.

The originally provided blank material 3 may have defects such as burrs, deformation, and dimensional deviations, and such defects may prevent the blank material 3 from being placed into the mold cavity and subsequently halt the following process steps. Additionally, since the conductive structures 10 are mass-produced during preparation, there may be variations among different blank materials 3, and these differences may ultimately lead to variations in the conductive structures 10. The purpose of the second shaping process is, on the one hand, to improve the consistency of the blank materials 3, and on the other hand, to ensure that the blank material 3 can be placed into the mold cavity.

As an example, the second shaping process includes: placing the originally provided blank material 3 into a shaping fixture for shaping, and using the shaping fixture to improve the dimensional consistency of the blank materials 3.

As an example, the second shaping process includes, but is not limited to, at least one of die cutting process, polishing process, and grinding process.

As an example, the blank material 3 is a copper-aluminum composite column, and the copper-aluminum composite column is subjected to cutting to remove a small amount of copper material adhered to a top surface of the aluminum layer.

In an aspect, the manufacture method of the conductive structure further includes:
S14, before placing the blank material 3 in the mold cavity, screening the blank material 3 such that the second layer 32 faces the bottom wall of the mold cavity when the blank material 3 is fed into the mold cavity.

During the manufacturing process, the conductive structures 10 are mass-produced. During the manufacturing process, the blank materials 3 may experience situations such as tipping over or reversing, which may affect the feeding process, especially automatic feeding. Therefore, the blank materials 3 are screened before feeding, and the blank materials 3 meeting the requirements are screened out for feeding. The reversing here means that the orientation of the first layer 31 and the second layer 32 in the blank material 3 is opposite to what is required. For example, when feeding, it is required that the first layer 31 in the blank material 3 is facing upward and the second layer 32 is facing downward, when the first layer 31 in the blank material 3 is facing downward and the second layer 32 is facing upward, it is considered reversing.

As an example, the columnar blank materials 3 may be placed in a screening tray, and the screening tray may be used to screen the blank materials 3 so that the orientation of the first layer 31 in the screened blank materials is consistent and meets the requirements.

In an aspect, referring to (d) in FIG. 29 and (d) in FIG. 30, the manufacture method of the conductive structure further includes:
S31, placing the semi-finished product 4 in a second cold heading die, and pressing a side surface of the first layer 31 facing away from the second layer 32.

This refers to performing a secondary cold heading process on the semi-finished product 4, where the second cold heading mold can be used to further adjust the size, shape, etc., of the semi-finished product 4. If a different second cold heading mold is used, the shape of the resulting conductive structure 10 is also different.

The manufacturing method of the conductive structure 10 provided in the embodiments of the present disclosure can also effectively improve the production efficiency of the conductive structure 10, reduce the waste of materials, and better control the production cost, and the conductive structure 10 produced by the method has a stable dimension and is easy to meet product usage requirements.

In an aspect of the present disclosure further provide a cover plate assembly. The cover plate assembly is configured to fit with a shell of the battery cell to form a closed accommodating cavity, and the accommodating cavity is configured to accommodate an electrode assembly of the battery cell.

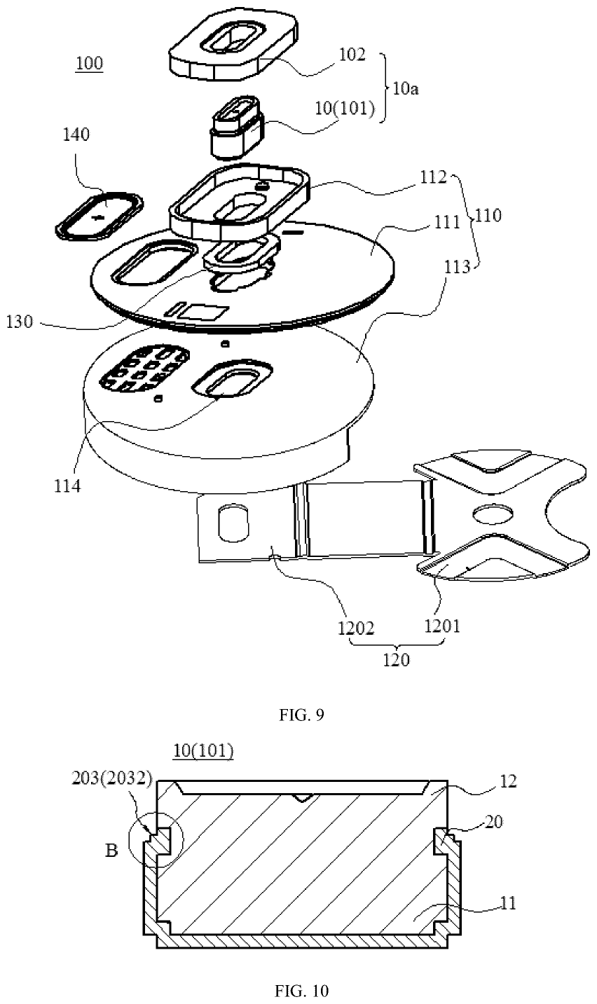

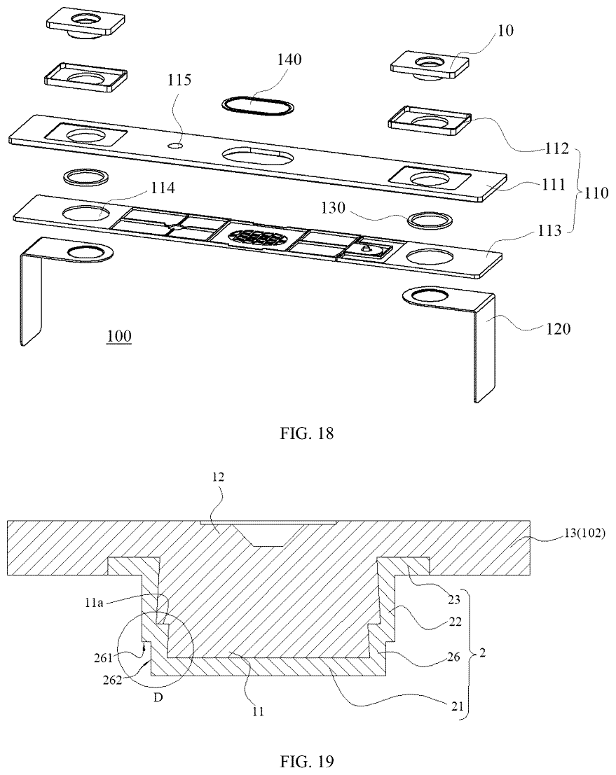

Referring to FIG. 8, FIG. 9, and FIG. 18, the cover plate assembly 100 includes a cover plate 110 and the aforementioned conductive structure 10 (which may be the conductive structure 10 provided in the first aspect or the conductive structure 10 manufactured by the method provided in the second aspect), and the conductive structure 10 is connected to the cover plate 110. The conductive structure 10 is provided penetrating the cover plate 110.

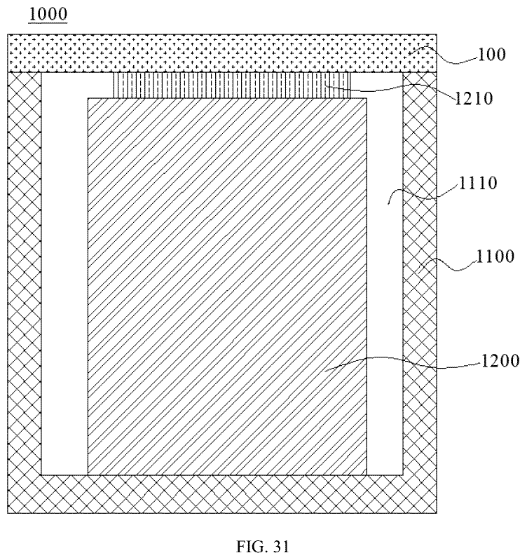

In detail, along a thickness direction of the cover plate 110, the cover plate 110 includes a first surface and a second surface opposite to each other. Referring to FIG. 31, when the cover plate assembly 100 is installed on the shell 1100 of the battery cell 1000, the first surface is a side surface away from the shell 1100, and the second surface is a side surface adjacent to the shell 1100. In the thickness direction of the cover plate 110, a mounting hole 114 is provided to penetrate through the cover plate 110, and the conductive structure 10 is provided penetrating the cover plate 110 via the mounting hole 114.

In an aspect, the conductive structure 10 is a pole 101, or the conductive structure 10 is a pole 101 and a terminal pressing block 102 integrated with each other. The cover plate assembly 100 further includes a current collector 120. The current collector 120 is a conductive component in the battery cell 1000 configured to connect with the tab 1210 of the electrode assembly 1200. The current collector 120 is located on a side of the cover plate 110, a side of the cover plate 110 facing away from the terminal pressing block 102, i.e. the current collector 120 is located on the second surface of the cover plate 110. The current collector 120 is welded to the conductive structure 10. The current collector 120 is welded to the second-metal layer 2 in the conductive structure 10. Optionally, the material of the current collector 120 is the same as the material of the second-metal layer 2, that is, the material of the current collector 120 is the second metal, so that the difficulty of welding between the current collector 120 and the second-metal layer 2 can be reduced and the reliability of welding can be improved.

In an aspect, the current collector 120 includes at least one of a current collecting plate and a connecting piece 1202.

In an aspect, referring to FIG. 9, the current collector 120 includes a current collector body 1201 and a connecting piece 1202. The current collector body 1201 is connected to the connecting piece 1202. The current collector body 1201 is configured to connect to the tab 1210 of the electrode assembly 1200, and the connecting piece 1202 is welded to the second-metal layer 2.

In an aspect, the cover plate 110 includes a cover plate body 111, a first insulating member 112, and a second insulating member 113. The first insulating member 112 and the second insulating member 113 are respectively arranged on opposite sides of the cover plate body 111. The first insulating member 112 is arranged between the conductive structure 10 and the cover plate body 111, and the second insulating member 113 is arranged between the cover plate body 111 and the current collector 120. Optionally, under the condition that the first-metal post 1 in the conductive structure 10 is provided with the boss 13, the first insulating member 112 is arranged between the boss 13 and the cover plate body 111. The cover plate 110 is provided with a mounting hole 114, the mounting hole 114 penetrates through the cover plate body 111, the first insulating member 112, and the second insulating member 113. As an example, the cover plate body 111 is an aluminum foil light sheet, and the first insulating member 112 and the second insulating member 113 are both plastic members.

In an aspect, the cover plate assembly 100 further includes a sealing member 130. The sealing member 130 is disposed between the cover plate 110 and the conductive structure 10, so as to seal a gap between the conductive structure 10 and the mounting hole to prevent electrolyte from leaking therefrom. As an example, the sealing member 130 is located between the cover plate body 111 and the second insulating member 113.

In an aspect, the assembly process of the cover plate assembly 100 includes: stacking the second insulating member 113, the sealing member 130, the cover plate body 111, and the first insulating member 112 in sequential hole alignment from bottom to top; inserting the conductive structure 10 through the mounting hole 114 from top to bottom such that a larger end (e.g., the boss 13) of the conductive structure 10 abuts on the first insulating member 112; installing the current collector 120 on a side of the second insulating member 113 facing away from the sealing member 130; and welding the current collector 120 to the conductive structure 10, e.g., the second-metal layer 2 in the conductive structure 10, by laser welding.

In an aspect, the cover plate assembly 100 further includes an explosion-proof valve 140, and the explosion-proof valve 140 is disposed on the cover plate 110.

In an aspect, the cover plate 110 is further provided with a liquid-injecting hole 115 and a sealing structure (not shown) for sealing the liquid-injecting hole.

In an aspect, referring to FIG. FIG. 31, embodiments of the present disclosure also provide a battery cell 1000. The battery cell 1000 is also referred to as a battery core, and the battery cell 1000 refers to a basic unit that realizes mutual conversion of chemical energy and electrical energy.

Referring to FIG. 31, the battery cell 1000 includes a shell 1100, an electrode assembly 1200, and the aforementioned cover plate assembly 100. The shell 1100 includes an accommodation cavity 1110, the electrode assembly 1200 is disposed in the accommodation cavity 1110, and the cover plate assembly 100 is connected to the shell 1100 and closes an opening of the accommodation cavity 1110. The electrode assembly 1200 includes a tab 1210, and the conductive structure 10 is connected to the tab 1210.

The electrode assembly 1200 further includes an electrode sheet and a diaphragm, and the tab 1210 is connected to the electrode sheet. The electrode sheet includes a positive electrode sheet and a negative electrode sheet, and the diaphragm is located between the positive electrode sheet and the negative electrode sheet. It can be understood that the tab 1210 also includes a positive tab and a negative tab. The positive tab is connected to the positive electrode sheet, and the negative tab is connected to the negative electrode sheet.

The battery cell 1000 further includes the electrolyte. The electrolyte is located in the accommodation cavity 1110, and the electrode assembly 1200 is immersed in the electrolyte.

The examples of the present disclosure have been described in detail above, and the principles and implementations of the present disclosure have been described herein with specific examples, and the description of the above implementations is only for helping to understand the methods and core ideas of the present disclosure. Meanwhile, those skilled in the art may change the examples and the scope of disclosure according to the ideas of the present disclosure, and in summary, the contents of the present specification should not be construed as limiting the present disclosure.

1. A conductive structure comprising:
a metal post including a first end and a second end opposite to each other; and
a metal layer being bonded to a surface of the metal post, wherein the metal layer wraps the first end of the metal post and extends toward the second end of the metal post, and the metal layer being configured to connect to a tab.

2. The conductive structure according to claim 1, wherein the metal layer and the metal post are cooperated with each other.

3. The conductive structure according to claim 2, further comprising an end portion of the metal layer being embedded in the metal post.

4. The conductive structure according to claim 3, further comprising a gap being presented between the end portion of the metal layer and the metal post.

5. The conductive structure according to claim 4, further comprising an end surface and a transition surface being formed on the end portion of the metal layer, and the gap being formed only between the end surface and the transition surface and the metal post, wherein a side of the end surface away from the transition surface is connected to an outer surface of the metal layer, and the transition surface is curved and transitioned from the end surface to the metal post; and an average dimension of the gap is less than 0.1 mm.

6. The conductive structure according to claim 1, wherein an end portion of the metal layer comprises a first extension segment and a second extension segment, the first extension segment extending in a first direction, the second extension segment extending in a second direction, and the first direction intersecting with the second direction.

7. The conductive structure according to claim 1, wherein the conductive structure is a pole, a supporting surface being formed on an end portion of the metal layer, and the supporting surface being configured to support a terminal pressing block.

8. The conductive structure according to claim 7, wherein the supporting surface is an inclined surface in a direction away from the first end, the inclined surface gradually approaches an outer side surface of the metal post from an outer side surface of the metal layer.

9. The conductive structure according to claim 8, wherein the inclined surface is an inclined flat surface, and an angle between the inclined flat surface and the outer side surface of the metal layer ranges from 110° to 130°.

10. The conductive structure according to claim 7, wherein the supporting surface is a step surface, the step surface including a first sub-step surface and a second sub-step surface, a number of the first sub-step surface is greater than or equal to 1, and a number of the second sub-step surface is greater than or equal to 1.

11. The conductive structure according to claim 10, further comprising a height of the second sub-step surface along an axial direction of the pole is greater than or equal to 0.2 mm, and a width of the first sub-step surface along a radial direction of the pole is greater than or equal to 0.2 mm.

12. The conductive structure according to claim 7, wherein a width of the supporting surface along a radial direction of the pole is greater than or equal to 0.3 mm, and is less than or equal to a thickness of the metal layer.

13. The conductive structure according to claim 1, wherein the metal post is an aluminum post, and the metal layer is a copper layer.

14. The conductive structure according to claim 13, wherein an average thickness of the metal layer ranges from 0.1 mm to 3 mm.

15. A cover plate assembly comprising:
a cover plate; and
a conductive structure comprising
a metal post including a first end and a second end opposite to each other, and
a metal layer being bonded to a surface of the metal post, wherein the metal layer wraps the first end of the metal post and extends toward the second end of the metal post, and the metal layer being configured to connect to a tab; and
wherein the conductive structure is provided penetrating the cover plate.

16. The cover plate assembly according to claim 15, wherein the conductive structure is a pole, or the conductive structure is a pole and a terminal pressing block integrated with each other; and
the cover plate assembly further comprises a current collector, and the current collector is located on a side of the cover plate and welded to the conductive structure.

17. The cover plate assembly according to claim 16, wherein the cover plate further comprises:
a cover plate body;
a first insulating member disposed between the conductive structure and the cover plate body;
a second insulating member disposed between the cover plate body and the current collector; and
wherein the cover plate assembly further comprises a sealing member, and the sealing member is disposed between the cover plate and the conductive structure.

18. A battery cell comprising:
a shell comprising an accommodating cavity;
an electrode assembly being disposed in the accommodating cavity, wherein the electrode assembly comprises a tab; and
a cover plate assembly comprising
a cover plate,
a conductive structure including a metal post and a metal layer,
the metal post including a first end and a second end opposite to each other, and
the metal layer being bonded to a surface of the metal post, wherein the metal layer wraps the first end of the metal post and extends toward the second end of the metal post, and the metal layer being configured to connect to a tab; and
wherein the cover plate assembly is connected to the shell and closes an opening of the accommodating cavity, and the conductive structure is connected to the tab.

19. The battery cell according to claim 18, wherein the metal layer comprises a first section, a second section, and a third section, the first section corresponds to an end surface of the first end, the second section corresponds to a side surface of the first end, the third section corresponds to a side surface of the boss adjacent to the first end, and the second section connects the first section with the third section.

20. The battery cell according to claim 19, wherein the third section is formed as an end portion of the metal layer, and the third section is embedded in a boss.
